(19) United States
(12) Patent Application Publication
(10) Pub. No.: US 2009/0025869 A1
(43) Pub. Date: Jan. 29, 2009

(54) Method Of Making A Vision Control Panel Using Cut Film

(75) Inventor: G. Roland Hill, Stockport (GB)

Correspondence Address: PILLSBURY WINTHROP SHAW PITTMAN, LLP, P.O. BOX 10500, MCLEAN, VA, 22102, US

(73) Assignee: CONTRA VISION LIMITED, Bramhall, Cheshire (GB)

(21) Appl. No.: 12/088,151

(22) PCT Filed: Sep. 27, 2006
(86) PCT No.: PCT/IB2006/004217

§ 371 Date: Jul. 15, 2008

Related U.S. Application Data
(60) Provisional application No. 60/720,462, filed on Sep. 27, 2005.
(60) Provisional application No. 60/727,462, filed on Oct. 18, 2005.

(51) Int. Cl. B32B 38/04

(52) U.S. Cl. 156/250

(57) ABSTRACT

A method of making a vision control panel includes cutting film material in a cutting pattern that includes a plurality of elongate film areas and a plurality of removable elongate film areas. The plurality of removable elongate film areas are optionally connected by a removal connector area. The method also includes separating the plurality of removable elongate film areas from the plurality of elongate film areas by means of an adhering surface, for example by using a removal connector area and/or adhesive tape. The method further includes applying a cut film pattern to a sheet of light permeable material, typically a transparent material, to form a vision control panel. Optionally, two vision control panels are made using alternate elongate film areas and removable alternate elongate film areas, from a single area of self-adhesive film.

### CROSS-REFERENCE

This application claims the benefit of priority from U.S. Provisional Patent Application Ser. No. 60/720,462, titled “Method of Making a Vision Control Panel Using Cut Film,” filed Sep. 27, 2005, and U.S. Provisional Patent Application Ser. No. 60/727,462, titled “Method of Making a Vision Control Panel Using Cut Film,” filed Oct. 18, 2006, both of which are hereby incorporated by reference in their entirety

### FIELD OF THE INVENTION

This invention relates to a method of making a vision control panel, typically a see-through graphic panel, which uses cut film in a “cut film pattern” to partially cover a light permeable material, typically a transparent material. Optionally a design is superimposed on or forms part of the cut film pattern.

### BACKGROUND TO THE INVENTION

Self-colored (single or mono-colored) self-adhesive vinyl films are commonly kiss-cut, for example to form signs comprising indicia. The indicia are either die-cut or more commonly cut with the knife or blade of an X-Y plotter/cutter, after which the surrounding area to the indicia is removed in one pull and any further unwanted colored vinyl, for example the areas inside indicia such as the letters “a”, “b” or “d” or numbers “6”, “8” or “9” are removed, typically by hand “weeding” with the aid of a scalpel, or by automatic weeding. Automatic weeding can be executed, for example, using equipment supplied by MGE/Dicon, USA. Cut printed vinyl is also known, for example to make signs with differently colored indicia.

The production of vision control panels by the use of cut self-adhesive film, for example to form a perforated material or a pattern of lines, is disclosed in U.S. RE37,186, the contents of which are incorporated by reference herein, which also describes other methods of making such one-way vision control panels, such panels being marketed as Contra Vision® (a trademark of Contra Vision Ltd). Perforated self-adhesive film assemblies for imaging by printers and application to windows to form vision control panels according to U.S. RE37,186 have been marketed since 1993, for example Contra Vision® Performance™ (a trademark of Contra Vision Ltd) and other products licensed under U.S. RE37,186 and family member patents. These have included perforated assemblies comprising white on black layers for application to the outside of windows after imaging of the white surface with a design, and clear, transparent film for application to the inside of windows after imaging of the clear perforated film with a reverse (mirror) image of the design to be visible from outside the window, typically followed by white and black “opacity layers”, for example by screen printing ink or thermally transferring pigmented resin layers according to U.S. Pat. No. 6,254,711.

U.S. RE37,186 and U.S. Pat. No. 6,267,052 disclose cut film “stripes” on a roll for imaging and application to a window to form vision control panels.

U.S. Pat. No. 6,267,052 discloses the cutting of a self-adhesive film on a roll into continuous lines or “stripes” in the direction of the web, by means of a cylindrical cutter. The stripes are continuous along the length of the roll with no transverse cuts or uncut portions. U.S. Pat. No. 6,267,052 also discloses that alternate stripes are optionally transferred to another liner, which is then wound onto a wind-up spool, to make two rolls of self-adhesive stripes out of one roll of self-adhesive film. This longitudinal orientation of stripes is the apparently most logical method of producing a pattern of self-adhesive stripes. It is also the most practical orientation of stripes for many methods of imaging, for example by means of a digital thermal transfer printer such as the Gerber Edge™ (a trademark of Gerber Instruments, Inc., USA), as disclosed in U.S. Pat. No. 6,267,052, in which the thermal transfer heads are orientated perpendicular to the stripes and provide continuous imaging capability of the stripes. Relative perpendicular movement between thermal transfer heads and the cut edges of film stripes is undesirable, either by the thermal transfer heads moving across a static array of stripes or the cut stripes attached to a liner being parallel to and moved across stationary thermal transfer heads. Thermal transfer heads are delicate and liable to damage by interaction with such an array of discontinuous film projecting from the liner web. They are expensive to replace if damaged. However, other thermal transfer machines, for example the Roland P600 (a trademark of Roland DG Corporation, Japan) have thermal transfer heads which move perpendicular to the direction of the web and stripes perpendicular to the web would be preferable for such machines. An even greater advantage of the arrangement of stripes perpendicular to a web is that the majority of digital inkjet machines are designed to print rolls of substrate and the printheads typically travel transversely in relation to the movement of the substrate through the machine.

Prior art FIG. 1A illustrates that with an inkjet printhead 60 printing a design 40, moving perpendicular to a prior art cut film pattern of longitudinal stripes 34, ink 42 forming design 40 is deposited on the leading edge 21 of the prior art longitudinal stripes 34. The stripes comprise facestock film 22 and adhesive layer 25 with leading edges 21 on removable liner 26. In FIG. 1B, the vision control panel 6 comprises printed, prior art stripes 34 which have been transferred to transparent light permeable material 10. The ink 42 on the leading edges 21 of the stripes 34 can be seen by observer 8 from the other side of the vision control panel 6 in what is termed in the art as a “ghost image”, which is a feint, mirror image of the design 40, whereas the design 40 is only desired to be seen from one side and not from the other side of a one-way vision panel according to US RE37,186.

U.S. Pat. No. 6,267,052 discloses that, in the manufacture of one-way vision panels according to US RE37,186 by means of cut stripes, the cut self-adhesive film forming the opaque “silhouette pattern” typically comprises either white PVC film and black PVC film laminated together to form a composite facestock film or a white PVC film with a black pressure-sensitive adhesive. These two constructions each provide a white surface on which to print a design to be visible from one side of the panel and a black surface visible from the other side of the panel, to enable good through-vision from the other side of the panel. U.S. Pat. No. 6,267,052 also discloses the use of cut clear, transparent film stripes to be imaged with a reverse image of a design, backed up by white and black layers, to be applied to a window.

U.S. Pat. No. 6,212,805 discloses the use of a translucent “base pattern” on a transparent sheet to make a see-through vision control panel which can be backlit. Such panels are marketed under the name of Contra Vision® BACKLITE™ (a trademark of Contra Vision Ltd, UK). One of the methods disclosed in U.S. Pat. No. 6,212,805 of forming the base pattern uses perforated self-adhesive film. Another method disclosed in U.S. Pat. No. 6,212,805 is the use of cut vinyl stripes to form the base pattern.

U.S. RE37,186 and U.S. Pat. No. 6,267,052 also disclose the use of a carrier, for example a transfer tape or application tape, or a clear transparent overlaminate film applied to design-imaged, self-adhesive stripes, to maintain the stripes in their desired geometrical relationships when being applied to a window. If this film is transparent, it can also act as a permanent overlaminate, and also assists the removal of the stripes from the window after the sign is no longer wanted. The discrete stripes would otherwise require individual removal. A permanent overlaminate also avoids dirt and rain entering the gaps between the self-adhesive stripes.

In the prior art of label manufacture from self-adhesive film, the facestock film is typically white and is typically first printed with a plurality of a particular label design. The edges of the individual labels are “kiss-cut” through the facestock film and optionally through part or all of the pressure-sensitive adhesive layer, for example by die-cutting or by the use of a computer driven X-Y plotter/cutter, and the unwanted facestock film around the labels is removed, typically onto a “take-up” or “wind-up” spool with a disposable sleeve in a web process, or is otherwise removed by hand. The removed material has the shape of a ladder if a single label is produced on the width of a roll, or is a rectangular grid pattern if more than one label is produced across the width of the roll.

It is known to convert photographic or other images into representational graphic signs comprising self-colored, kiss-cut vinyl by “vectography”, in which an array of discrete areas of varying size represents the varying “greytones” of the image in the selected colored vinyl. The discrete areas can be of any shape or size, for example dots or lines of varying width, to represent the “greytone” or darkness of the image at any point in the sign. Such vectography signs are typically able to be weeded in one “sweep” or “pull” of unwanted film, as the areas which form the design image are all discrete areas. Such signs may be manufactured, for example using the computer software ProCut Plus™, a trademark of Graphical Systems, Oregon, USA.

In such vectography, it is also known that curved shapes assist such “one pull” or “single sweep” removal of the unwanted material, being preferable to angled corners or other sharp discontinuities, which can cause stress concentrations leading to the vinyl tearing at such points instead of the continuous removal of the unwanted film. The discrete vectographic sign elements remaining on the liner are then transferred by means of self-adhesive application tape to a base material, typically opaque, and the application tape is then removed, leaving the discrete vectographic sign elements on the base material, to form the required sign.

EP 1 530 188 discloses a method of making a vision control panel comprising cut film, typically cut film lines, and discloses the removal of unwanted, cut film after application of the imaged, film assemblies to a window.

### SUMMARY OF THE INVENTION

According to an embodiment of the present invention, there is a method of making a vision control panel comprising the steps of:

(i) cutting a film material in a cutting pattern comprising a plurality of elongate film areas and a plurality of removable elongate film areas,

(ii) separating said plurality of removable elongate film areas from said plurality of elongate film areas, and

(iii) applying a cut film pattern comprising said plurality of removable elongate film areas or said plurality of elongate film areas to a sheet of light permeable material to cover a substantially uniform proportion of said sheet of light permeable material, characterized in that said separating uses an adhering element.

Embodiments of the method of making a vision control panel, typically a see-through graphic panel, typically use cut self-adhesive film in a “cut film pattern” to partially cover a light permeable material, typically a transparent material, while maintaining light transmissivity and, typically, a see-through vision capability. A design is optionally superimposed on or forms part of the cut film pattern.

For example, in a first embodiment, a self-adhesive film comprises a facestock film, for example a polyvinyl chloride (PVC) facestock film, a pressure-sensitive adhesive and a removable liner. The self-adhesive film is “kiss-cut” (the facestock film is cut but not the liner) to form the “cut film pattern”, typically a pattern comprising straight or curved elongate areas or “stripes”, and removing or “weeding” unwanted film and adhesive material. Optionally a design is applied to the facestock film, either prior to or after removal of the unwanted film. The removed film material optionally includes a “removal connector area” which connects otherwise discrete removable elongate film areas at one end, enabling the efficient multiple weeding of the otherwise discrete removable elongate film areas of unwanted material. The adhering surface of the pressure-sensitive adhesive layer enables the separation of the removable elongate film areas from the elongate film areas by retaining the elongate film areas on the removable liner. Typically, a temporary self-adhesive “application tape” or a permanent overlaminate film, is then typically applied to the facestock film or design surface. The application tape or overlaminate film holds the cut stripes of self-adhesive film in their required position after removal of the liner and before application of the imaged, self-adhesive cut film pattern to a light permeable material, typically transparent, for example a window, to form the vision control panel. If a temporary application tape has been used, it is then removed, leaving the cut film pattern on the light permeable material. If a permanent overlaminate film is used, this is typically transparent and prevents the ingress of dirt and rainwater onto the light permeable material between the stripes, as well as assisting the subsequent removal of the stripes in one “pull”. Optionally, a “residual connector area” joins the other ends of the elongate film areas or stripes of the cut film pattern. The residual connector area is either cut off or is retained in the finished vision control panel. A retained residual connector area has several potential benefits, for example to assist subsequent removal of the cut film pattern forming the sign in one piece from the light permeable material and/or to form a continuous background to part of the design, for example a central feature of the design, or an area in which small indicia are printed that otherwise would not be clearly legible, and/or to act as an electrical “bus bar”, for example in a one-way vision, electroluminescent sign. The removal of the unwanted material is optionally assisted by an adhering surface, typically a self-adhesive tape applied to the removal connector area, for example to reinforce it and assist separation of the facestock film layer and adhesive layer from the removable liner.

In a second embodiment, the cut film pattern comprises the removable elongate film areas, which are removed by means of an adhering surface, typically a self-adhesive application tape.

In a third embodiment, both the removable elongate film areas and the elongate film areas are used to form cut film patterns in two separate vision control panels.

One object of one or more embodiments of the invention is to efficiently produce stripes of self-adhesive film on a removable liner which are orientated substantially perpendicular to or at an angle to the length of the removable liner, to substantially avoid the ghost images resulting from the inkjet printing of prior art longitudinal stripes. Another object of one or more embodiments of the invention is to enable the efficient removal of elongate areas of film from a temporary liner or from a light permeable material such as a window, in one “sweep” or “pull”, with or without the use of another self-adhesive film assembly. A further object of one or more embodiments of the invention is to provide one or more connector areas in the finished panel, to provide one or more of a variety of potential benefits as described herein. A still further object of one or more embodiments of the invention is to enable a customer of a cut, optionally imaged, self-adhesive film assembly to separate from removable elongate film areas to form a cut film pattern immediately prior to its application to a window, requiring less labour and/or materials than prior art methods of producing a vision control panel by means of cut film stripes. Yet another object of one or more embodiments of the invention is to product two vision control panels from one self-adhesive film assembly, with no film wastage.

Additional and/or alternative advantages and salient features of the invention will become apparent from the following detailed description which, taken in conjunction with the annexed drawings, disclose preferred embodiments of the invention.

### BRIEF DESCRIPTION OF THE DRAWINGS

In numbering the following drawings, the postscript letters do not include the letters “T” or “O”.

FIG. 1A is a cross-section of a prior art arrangement of self-adhesive, kiss-cut stripes being printed by a digital inkjet printer.

FIG. 1B is a cross-section of a prior art vision control panel comprising self-adhesive stripes.

FIGS. 2A-4G illustrate diagrammatic stages in production using the first embodiment for external application.

FIG. 2A is a diagrammatic plan view of part of a roll of self-adhesive film which has been kiss-cut in a cutting pattern.

FIG. 2B is a diagrammatic cross-section through the kiss-cut roll of self-adhesive film in FIG. 2A.

FIG. 2C is a diagrammatic plan view of the roll of self-adhesive film of FIG. 2A with unwanted film removed.

FIG. 2D is a diagrammatic cross-section through the roll of self-adhesive film in FIG. 2C.

FIG. 2E is a diagrammatic plan view of the roll of self-adhesive film of FIG. 2C in which the film has been imaged with a design.

FIG. 2F is a diagrammatic cross-section through the roll of self-adhesive film of FIG. 2E.

FIG. 2G is a diagrammatic cross-section through the roll of self-adhesive film of FIG. 2F showing an overlaminate film.

FIG. 2H is a diagrammatic cross-section through the self-adhesive film of FIG. 2G with the removable liner having been removed.

FIG. 2J is a diagrammatic cross-section through the self-adhesive film of FIG. 2H attached to a light permeable material to form a vision control panel.

FIG. 2K is a diagrammatic plan view of the vision control panel of FIG. 2J.

FIG. 2L is a diagrammatic part plan view of FIG. 2A with the addition of an adhering surface.

FIG. 2M is a diagrammatic part plan view of FIG. 2A with the addition of an adhering surface.

FIG. 3A is a diagrammatic plan view of part of a roll of self-adhesive film which has been kiss-cut in a cutting pattern.

FIG. 3B is a diagrammatic cross-section through the kiss-cut roll of self-adhesive film in FIG. 3A.

FIG. 3C is a diagrammatic plan view of the roll of self-adhesive film of FIG. 3A with unwanted film removed.

FIG. 3D is a diagrammatic cross-section through the roll of self-adhesive film in FIG. 3C.

FIG. 3E is a diagrammatic plan view of the roll of self-adhesive film of FIG. 3C in which the film has been imaged with a design.

FIG. 3F is a diagrammatic cross-section through the roll of self-adhesive film of FIG. 3E.

FIG. 3G is a diagrammatic cross-section through the roll of self-adhesive film of FIG. 3F showing an overlaminate film.

FIG. 3H is a diagrammatic cross-section through the self-adhesive film of FIG. 3G with the removable liner having been removed.

FIG. 3J is a diagrammatic cross-section through the self-adhesive film of FIG. 3H attached to a light permeable material to form a vision control panel.

FIG. 3K is a diagrammatic plan view of the vision control panel of FIG. 3J.

FIG. 3L is a diagrammatic plan view of part of a roll of self-adhesive film which has been kiss-cut in a cutting pattern.

FIG. 3M is a diagrammatic plan view of a roll of cut self-adhesive film which has been imaged with a design.

FIG. 3N is a diagrammatic cross-section through the imaged, self-adhesive film of FIG. 3M.

FIG. 3P is a diagrammatic plan showing unwanted material removed.

FIG. 3Q is a diagrammatic plan view of a finished vision control panel.

FIG. 3R is a diagrammatic plan view of a roll of film imaged with a design.

FIG. 3S is a cross-section through the imaged film of FIG. 3R.

FIG. 3T is a cross-section showing the imaged film of FIG. 3S to which an adhesive layer and liner have been attached.

FIG. 3U is a cross-section similar to FIG. 3T with added application tape.

FIG. 3V is a cross-section similar to that in FIG. 3U but in the perpendicular direction.

FIG. 3W is a cross-section similar to 3V but with a liner removed.

FIG. 3X is a cross-section similar to FIG. 3W but with the cut, imaged assembly applied to a light permeable material.

FIG. 3Y is a cross-section though a light permeable material and a self-adhesive assembly showing the removal of unwanted material.

FIG. 4A is a diagrammatic plan view of part of a roll of self-adhesive film which has been kiss-cut in a cutting pattern.

FIG. 4B is a diagrammatic plan view of part of a roll of self-adhesive film which has been kiss-cut in a cutting pattern.

FIG. 4C is a diagrammatic plan view of part of a roll of self-adhesive film which has been kiss-cut in a cutting pattern and imaged with a design.

FIG. 4D is a diagrammatic plan view of part of a roll of self-adhesive film which has been kiss-cut in a cutting pattern and imaged with a design.

FIG. 4E is a diagrammatic plan view of part of a roll of self-adhesive film which has been kiss-cut in a cutting pattern.

FIG. 4F is a diagrammatic plan view of part of a roll of self-adhesive film which has been kiss-cut in a cutting pattern.

FIG. 4G is a diagrammatic cross-section through a film laminate.

FIGS. 5A-6J illustrate diagrammatic stages in production using the first embodiment for internal application.

FIGS. 5A-F are diagrammatic cross-sections.

FIG. 6A is a diagrammatic cross-section of a self adhesive assembly.

FIG. 6B is a diagrammatic plan of a roll of self-adhesive film imaged with a design.

FIGS. 6C-J are diagrammatic cross-sections.

FIGS. 7A-J illustrate diagrammatic stages in production using the second embodiment for external application.

FIGS. 7A and 7B illustrate diagrammatic plan views.

FIGS. 7C-G are diagrammatic cross-sections.

FIG. 7H is a diagrammatic plan.

FIG. 7J is a diagrammatic cross-section.

FIGS. 8A-8D illustrate diagrammatic stages in production using the second embodiment for internal application.

FIGS. 9A-F are diagrammatic plan view stages in production using the third embodiment for external application to a window.

FIGS. 10A and 10B are diagrammatic cross-sections of stages in production using the third embodiment for internal application to a window.

FIG. 11A illustrates alternative production flow charts for the first embodiment, for external application.

FIG. 11B illustrates alternative production flow charts for the first embodiment, for internal application.

FIG. 12A illustrates alternative production flow charts for the second embodiment, for external application.

FIG. 12B illustrates alternative production flow charts for the second embodiment, for internal application.

FIG. 13A illustrates alternative production flow charts for the third embodiment, for external application.

FIG. 13B illustrates alternative production flow charts for the third embodiment for internal application.

FIG. 14 is a table setting out the method options of the first, second and third embodiments for each principal stage of production.

FIGS. 15A-17 are diagrammatic representations of production stages using a pre-cut “part processed material”.

FIGS. 18A and B are diagrammatic cross-sections in production using two release liners, one to be retained in the finished panel.

FIG. 19A is a diagrammatic plan of a cut film pattern with staggered leading edges to the elongate areas.

FIG. 19B is a diagrammatic plan of a cut film pattern with staggered leading edges to the elongate areas.

FIGS. 19C-E illustrate diagrammatic stages in production of the third embodiment using staggered leading edges.

FIG. 19F is a diagrammatic part plan of a cut film pattern with elongate areas with staggered leading edges and an adhering surface, in production of the first embodiment.

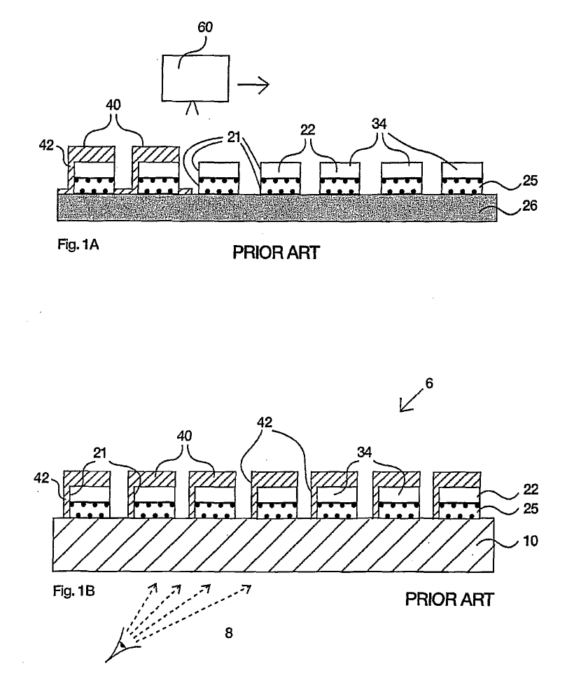

### DETAILED DESCRIPTION OF EMBODIMENTS OF THE INVENTION

The term “light permeable material” as used herein is intended to mean a material that allows light to pass through it and includes a “transparent material” and a “translucent material”. Examples of light permeable materials include sheets of glass, polyvinyl chloride, polyester, acrylic and polycarbonate.

The term “transparent material” as used herein is intended to mean a transparent material that has two substantially parallel and plane surfaces or otherwise allows clarity of vision from one side of the material through the material, enabling the eye to focus on an object spaced from the other side of the material and thus providing a substantially undistorted image of the object. The material does not have to be colorless or “water clear” but may be tinted to any required color.

The term “translucent material” as used herein is intended to mean a material which will allow light transmission but is not a transparent material (as defined herein).

A “cutting pattern” is a geometric pattern of cut lines within a roll or sheet of film, cut to enable the production of a “cut film pattern”.

A “cut film pattern” comprises a plurality of “elongate film areas” which are sometimes referred to herein as “stripes”. In the finished vision control panel, the “cut film pattern” subdivides the light permeable material into portions of light permeable material covered by cut film and portions of light permeable material devoid of cut film. A cross-section can be taken through the panel which comprises two edges of the light permeable material and alternate filmic portions and non-filmic portions. The cut film pattern preferably covers a substantially uniform proportion of the light permeable material in at least one part of its area. The substantially uniform proportion of the light permeable material covered by the cut film pattern is typically in the range of 40%-80% of the area of the light permeable material. A cut film panel optionally comprises non-uniform elements, for example an uncut area on which is superimposed the principal subject of a design.

An “elongate area” refers to an area that is long in proportion to its width. Elongate areas are typically rectilinear or curvilinear. Elongate areas have a length:width ratio that is preferably greater than 10:1, is more preferably greater than 20:1, and is even more preferably greater than 100:1.

“Elongate film areas” are elongate areas of film, at least the two long sides and optionally one or both ends of which are cut. Cut ends of elongate film areas or stripes may be straight but preferably are continuously curved or “radiused”, to reduce stress concentrations and thereby potential tearing of the film in the removal process. The elongate film areas of the cut film pattern preferably have a width of less than 1 cm with gaps between them of less than 1 cm. More preferably, the width of the elongate film areas of the cut film pattern is less than 5 mm with gaps between them of less than 5 mm and, even more preferably, the width of the elongate film areas of the cut film pattern is less than 3 mm with gaps between them of less than 3 mm. Examples of film materials include polyvinyl chloride (pvc), polycarbonate, acrylic, acetate and paper.

A “removal connector area” connects a plurality of “removable elongate film areas” and is used, typically, to enable removal of the removable elongate film areas in one “pull” or “sweep” from a liner or the sheet of light permeable material, avoiding the need to individually “weed” or remove each removal elongate film area.

The elongate film areas remaining on a liner, sometimes referred to herein as a release liner or a removable liner, are optionally connected by a “residual connector area”. A “residual connector area” has several potential uses, for example to assist transfer of removable elongate film areas from a liner and, subsequently, removal of the cut film pattern in one piece from the light permeable material and/or to form a continuous background to part of the design, for example a central feature of the design or an area in which small indicia are printed that otherwise would not be clearly legible.

The term “design” as used herein is intended to mean any graphic image such as indicia, a photographic image or a created image of any type. The design is typically perceived to be visually independent of the elements of the cut film pattern. This feature can be tested by an observer adjacent to one side of the panel from which the design is normally visible, who moves away from the one side of the panel in a perpendicular direction from the panel until individual elements of the cut film pattern can no longer be resolved by the eye of the observer, the design remaining clearly perceptible. The design comprises at least one “design layer”.

A “design layer” may be a single or “spot” color layer or may be a multi-color process layer, for example cyan, magenta, yellow, black (CMYK).

A “design color layer” is a single color layer within a design layer, for example a single spot color layer or a single color layer within a multi-color process design layer, for example cyan in a CMYK four color process design layer.

The term “translucent design” as used herein is intended to mean a design comprising a translucent material as defined herein. A translucent design typically comprises translucent inks, toners or other marking materials. Another part of a translucent design may be opaque. Another part of a translucent design may comprise transparent material as defined herein.

The method also applies to vision control panels without a design, having a uniform color visible from each side of the panel, either the same color or a different color from each side.

### Embodiment 1

In a first embodiment, the film material is typically the “facestock” of a self-adhesive film assembly, for example a self-adhesive vinyl (PVC), polyester or paper film. The facestock film may be a single layer, for example of white vinyl, or be a laminate of similar or different film materials, for example white vinyl and black vinyl or white vinyl and black polyester, or be of more complex construction, for example a retro-reflective film comprising half silvered glass microspheres or “cube corners” or an electroluminescent film assembly. The self-adhesive assembly typically comprises a release coated liner, for example a silicone coated paper liner, and a layer of pressure-sensitive adhesive between the facestock film and the liner. The self-adhesive assembly can be formed before printing or cutting the film, or a film can first be printed and then a layer of pressure-sensitive adhesive with a release liner added to form a self-adhesive assembly. This latter alternative enables printing by processes that cannot be efficiently used with a self-adhesive assembly, for example digital laser light exposure of photographic film that subsequently undergoes a liquid development process.

The self-adhesive film is “kiss-cut” (the facestock film is cut but not the liner) in a cutting pattern to form a “cut film pattern”, typically comprising elongate film areas. Removable elongate film areas connected by a “removal connector area” lie outside the cut film pattern.

A “removal connector area” optionally connects otherwise discrete removable elongate film areas at one end, sometimes referred to herein as the “leading edge”, enabling the efficient multiple weeding in one “pull” of the otherwise discrete removable elongate areas of unwanted material, as opposed to labour intensive individual weeding of each unwanted removable elongate film area. This unwanted facestock film material is preferably removed or “weeded” prior to or after printing the design on the facestock film, while it is still on the liner, as opposed to removing the unwanted cut film from a window. The peeling strength of the pressure-sensitive adhesive is much less on a release-coated liner than on a window, making the removal process easier. Optionally, a removal connector area is not incorporated into the cutting pattern but an adhering surface, typically an adhesive tape, is used to connect removable elongate areas, for example adhered to leading edges staggered beyond the leading edges of the elongate film areas of the cut film pattern, a method which also enables multiple weeding of removable elongate film areas in one “pull”.

A temporary “application tape” or a permanent clear overlaminate film is typically applied to the design-printed surface of the cut film pattern. The application tape or overlaminate film holds the cut stripes of self-adhesive film in their required position, after removal of the removable liner and before application of the imaged, self-adhesive cut film pattern to a light permeable material, typically transparent, for example a window, to form a see-through graphics vision control panel. If a temporary transfer tape is used, this is then removed to leave the finished panel whereas, if a permanent clear overlaminate film is used, this stays in place and prevents the ingress of dirt and rainwater onto the light permeable material between the stripes, as well as assisting the subsequent removal of the stripes in one “pull” or “sweep” when the vision control panel is no longer required.

The cutting pattern typically comprises elongate film areas and removable elongate film areas perpendicular to the length of a roll or sheet of film material. It is not normally practical to remove the unwanted film by the conventional method used in the production of self-adhesive labels, of winding up a sacrificial ladder or grid of unwanted material surrounding the individual areas required to remain. The typically small cross-sectional area of the removable elongate film areas spanning across the width of the roll of self-adhesive film is insufficiently strong to withstand the angled pulling (or tensile force) resulting from this prior art method of unwanted film removal, which is resisted by the adhesive bond to the removable liner, causing breakage of the transverse elements of the unwanted film. Removal of pressure-sensitive adhesive is done most efficiently by in-line peeling, not an angled pull. The unwanted material of removable elongate film areas is therefore typically removed by pulling a removal connector area or connecting adhesive tape away from the liner and back at an acute angle to and along the length of the removable elongate film areas. This removal of interconnected elongate film areas in one “pull” or “sweep” enables the economic production of vision control panels comprising a cut film pattern. For example, if a roll of self-adhesive film is cut into elongate areas perpendicular to its length, the roll of film typically has at least one edge uncut along the length of the panel which forms the “removal connector area”, to facilitate “weeding” removal of a plurality of removable elongate film areas in one piece, for example manually or by means of an automatic edge separating and weeding device travelling transversely across the roll width. Alternatively, the leading edges of the removable elongate film areas extend beyond the leading edges of the elongate film areas of the cut film pattern and a connecting adhesive tape is applied to the projecting leading edges to enable single “pull” weeding of the removable elongate film areas.

The cut film pattern typically comprises parallel straight or curved lines, for example curved in the form of joined semi-circles or in the form of a sinusoidal wave, typically across the width of a roll or sheet of film.

The cut film pattern optionally comprises discontinuous parallel straight or curved stripes, having discrete elongate film areas surrounded by interconnected areas of unwanted film.

Another possible means of producing a cut film pattern would be to weed discrete elongate film areas or “slots” so that, instead of continuous or discontinuous film stripes, there is an array of slots or elongate voids with cut film remaining between the slots and forming “bridging areas” across the ends of the slots. However this method would require individual weeding of each slot, by hand or automatically, in either case the removal process being less efficient than a simultaneous, single “sweep” or “pull” removal of a plurality of elongate film areas according to the preferred embodiments of the invention.

Typically, to enable film material to be removed by hand or by suction and/or gripper devices, a transverse cut extends across the whole width of a roll at each end of the cut film pattern, to enable the unwanted material to be removed transversely or longitudinally. These transverse cuts can be an “extra cut” or extension of a cut in the cut film pattern or be within a “transverse cutting zone”, which when cut down the middle forms two transverse framing edges. The existence of one, two, three or more uncut edges to a cut film pattern assists handling, any subsequent overlamination and edge trimming to the final desired panel size and, if retained in the vision control panel, future removal of the cut film pattern from the light permeable material, for example from a window.

There are many alternative cut film patterns, for example:
(i) elongate film areas disposed at an angle, for example at 45%, to the length of a roll or sheet of film, the removal connector area typically being formed by the edge of the roll of film, or
(ii) elongate film areas parallel to the length of a roll or sheet of film with a transverse removal connector area, or
(iii) a cut film pattern of interconnected elongate areas in a “parallel zigzag pattern” in which there is a plurality of removal connector areas, each connecting the ends of two adjacent elongate film areas. This cut film pattern is created by the removal of the unwanted film continuously along the zigzag pattern, for example by means of a suction tube tracking after the cutting device, or a suction tube with a splayed, low friction inner surface that is located centrally at sufficient distance above the roll to accommodate the different angles of film removal across the width of the roll.

The unwanted film material is typically removed manually by pulling a removal connector area away from the liner, bringing a plurality of removable elongate film areas with it. This process is optionally assisted by an adhesive tape applied onto the removal connector area or by a film removal bar to which the removal connector area is attached, for example by means of pressure-sensitive adhesive, or by a gripper device, or by insertion into a slot within the film removal bar, or by insertion into a split tube film removal bar. Alternatively, the unwanted film can be removed automatically, for example by means of a suction bed holding down the continuous edge of the liner and a series of suckers lifting an uncut edge of the roll of film (the removal connector area), then proceeding to remove all the unwanted film material by lateral translation of the suckers with attached film, or the lifted edge being gripped by a separate gripper device, for example akin to a piano hinge, which removes the unwanted material by translating across the roll of film. The ends of the elongate film areas or stripes may be straight but preferably are continuously curved or “radiused”, to reduce stress concentrations and thereby potential tearing of the film in the removal process.

In the first embodiment, the unwanted film material optionally comprises more than one removal connector area, for example a removal connector area at both ends of the removable elongate film areas.

Optionally, the cut film pattern comprises elongate film areas with a “residual connector area”. The residual connector area may be temporary or form a permanent part of the vision control panel. In either case, it enables a cutting pattern entirely within a roll or sheet of film. With some cutting techniques, it is practical to cut the film from and up to an edge, for example if a laser kiss-cutting method is used, for example to cut self-adhesive retro-reflective film comprising half-silvered glass beads. However, for the most efficient and recommended use of an X-Y plotter/cutter with a blade, the cutting pattern is typically spaced within the edges of the roll or sheet of film, with the exception of any end cuts to each panel, which are typically formed by a separate cutting action provided with standard printing or plotter/cutter equipment to cut off lengths of roll. A residual connector area is typically located at the opposite side of the roll or sheet to the removal connector area. Alternatively, a residual connector areas is spaced from the film edges, for example in a “tree-shaped” cut film pattern with a continuous residual connector area “trunk” along the centre of a sheet or roll of film and elongate film areas forming the “branches” of the “tree”. With such a cut film pattern, the removable elongate film areas are typically weeded by means of a removal connector area and/or adhesive tape on both, opposite edges of the roll or sheet of film. Optionally, a residual connector underlies a particular area of the overall design. For example, relatively small indicia are difficult to read if superimposed on a typical cut film pattern and a “selectively blocked” or uncut area of film is advantageously incorporated into the cutting pattern on which such small indicia can be printed. As another example, it is often advantageous to provide an uncut area on which to print a particularly important part of a design for maximum visibility, for example a company's logo in an advertisement or a principal subject or feature of a design, for example a car in a car advertisement, which is superimposed on a solid area within an otherwise substantially uniform cut film pattern of elongate film areas with intermediate non-filmic, transparent areas of the vision control panel. In this example, a scenic background to the car could be superimposed on the substantially uniform cut film pattern of elongate film areas.

### Embodiment 2

In a second embodiment, the cut film pattern comprises removable elongate film areas. The removed film optionally comprises a removal connector area at one or both ends of the removable elongate areas. The one or more removal connector areas can be cut off to form the vision control panel or are retained as part of the finished panel, for example for the same reasons as previously described in the first embodiment. As another example, an electroluminescent self-adhesive film assembly can be kiss-cut into a pattern of lines with a removal connector area at both ends which act as electrical “bus bars” in a one-way vision electroluminescent sign. Transfer of the removable elongate film areas from a release liner to the sheet of light permeable material is typically undertaken by means of an adhering surface, for example a self-adhesive “application tape”.

### Embodiment 3

In a third embodiment, the stages of production of the first and second embodiments are combined, the cutting pattern creating two separate cut film patterns, both of which are used to create two separate vision control panels, which may be referred to as panel I and panel II. Typically, cut film pattern I and cut film pattern II are of equal width stripes, each covering 50% of the area of their respective panels I and II.

In the second and third embodiments, in which removed film forms part of a vision control panel, the removal of cut film from the liner of a self-adhesive assembly is typically assisted by temporary self-adhesive application tape applied to the cut facestock film. A removal connector area and adhered application tape are then separated from the liner at the edge of the film and pulled back at an angle, ideally an acute angle, to the elongate film areas, which enables the desired removal of the cut film pattern but leaves elongate film areas on the liner. Providing the residual connector is being pulled at an acute angle to the film at the ends of the elongate film areas, the cut film pattern will normally be differentially removed, as described. Optionally, this differential removal of the cut film pattern is further ensured by the selective application of a release agent such as a silicone ink along the leading edges of the ends of the elongate film areas remaining on the liner. For example, a computer driven blade cutter can have a silicone ink felt tip pen fixed adjacent to the cutter blade, the computer only instructing the silicone ink pen to deposit silicone ink along the curved leading edges of the elongate film areas intended to remain on the liner. Alternatively, this separation and selective removal of the removable elongate film areas is enabled by their leading edges extending beyond the leading edges of the elongate film areas, as previously described.

In all three embodiments, the film is optionally printed with a design, for example comprising “spot” design color layers or a four color (CMYK) process image. Nearly all printing processes can be used in the method of the invention, including screen and litho printing, although it is particularly suited to digital printing processes, including inkjet, thermal transfer, electrostatic transfer and laser light printing of photographic film.

The automatic cutting of elongate areas of film that are perpendicular to or at an angle to the length of a roll of self-adhesive vinyl material typically uses a single cutting device, for example a blade or heated element which traverses across the width of the roll, as compared to the longitudinal prior art cut film pattern that typically requires an array of blades or cutting protrusions on a cylindrical cutter. Suitable equipment to undertake transverse or angular cutting are either independent of the imaging system or, preferably, are combined with the imaging system, for example in digital inkjet printers by Roland, Japan or the Gerber Edge by Gerber Scientific Products, Inc., USA. A cut film pattern can be cut by a cutting device which moves transversely to a roll and the roll is moved forwards and/or backwards, for example by means of a frictional feed in the case of Roland printers, or by means of punched sprocket holes in the case of the Gerber Edge. It is advantageous if the cutting pattern is formed by cut lines predominantly perpendicular to the length of the roll, as this minimises the forward and backward movement of the roll, requiring only small incremental forward and/or backward movements of the line widths and transverse movement of the cutting device. Alternatively, film can be cut on a flatbed X-Y plotter/cutter, for example as manufactured by Zund, Switzerland.

A clear overlaminate typically comprises a self-adhesive film, typically comprising a transparent film layer, for example of polyester or polyvinyl chloride, and a pressure-sensitive adhesive layer. Alternatively, the overlaminate is adhered by other means, for example is heat-sealed to the imaged surface of the imaged, cut film pattern. Preferably, the bond between the overlaminate and the imaged or unimaged cut film is greater than the bond between the self-adhesive and the window or other light permeable material to which the cut film pattern is applied, to facilitate the subsequent removal of a plurality of elongate areas of film in one piece, when the vision control panel is no longer required.

A cut film “part processed material” of self-adhesive vinyl kiss-cut with the desired cutting pattern, to result in the required cut film pattern, is optionally sold as an “engineered substrate” to printers. Printers typically image the engineered substrate, undertake the required film removal, apply any required application tape or clear overlaminate, remove the liner and apply the imaged cut film pattern to a window. For certain methods of printing, for example inkjet digital printing which can print a discontinuous surface, the mass-production of such engineered substrate optionally includes the removal of unwanted film prior to sale to printers for conversion of a “striped vinyl substrate” into vision control panels.

The film assembly optionally does not have a pressure-sensitive adhesive layer. For example, the film is optionally static (highly plasticized) polyvinyl chloride cling film on a suitable carrier or is film with a heat-activated adhesive and is heat-bonded to the light permeable sheet.

To form vision control panels disclosed in U.S. RE37,186 which have an opaque “silhouette pattern”, the film materially is typically opaque. For external application to the outside of a window, sometimes referred to as “first surface” application, the film typically comprises a white vinyl layer bonded to a black vinyl layer to form a composite facestock, with a pressure-sensitive adhesive layer applied to the black vinyl layer, or comprises a white vinyl facestock with a black pressure-sensitive adhesive layer, the white layer in each case typically having a print-receptive surface. In a finished panel with a design, the design is visible from one side of the panel (the outside of the window) but is not visible from the other side of the panel (the inside of the window). For internal application to the inside of a window, sometimes referred to as “second surface” application, the pressure-sensitive adhesive layer is applied to the imaged, white layer of a white and black laminate or a clear, transparent film facestock is printed with the reverse (mirror) image of the design required to be visible from outside the window. The design is typically “backed-up” by white and black “opacity layers”, for example by digital, screen or other printing process, or by pigmented resin white and black layers by thermal transfer, or by white and black film laminate layers prior to the cutting process, for example a white and black vinyl film laminate applied by pressure-sensitive adhesive to the reverse-imaged surface of the clear film. A light-absorbing, typically black layer is provided to enable good see-through qualities when the cut film is applied to the light-permeable material, typically the window of a building or vehicle.

Alternatively, see-through vision control panels can be of the type described in U.S. Pat. No. 6,212,805, in which the film layer is translucent or is transparent and is coated or printed to form a translucent “base layer” on which a translucent or transparent design is superimposed, such panels being capable of being illuminated from behind.

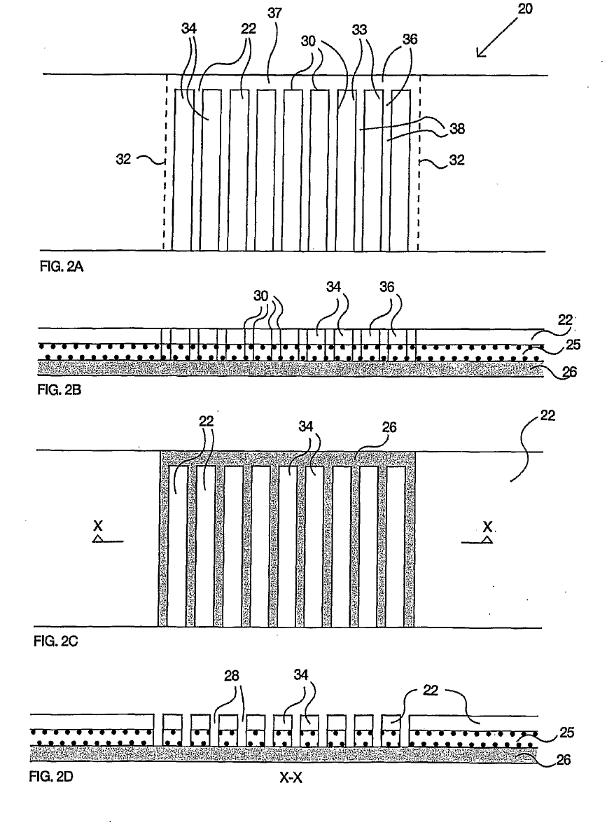

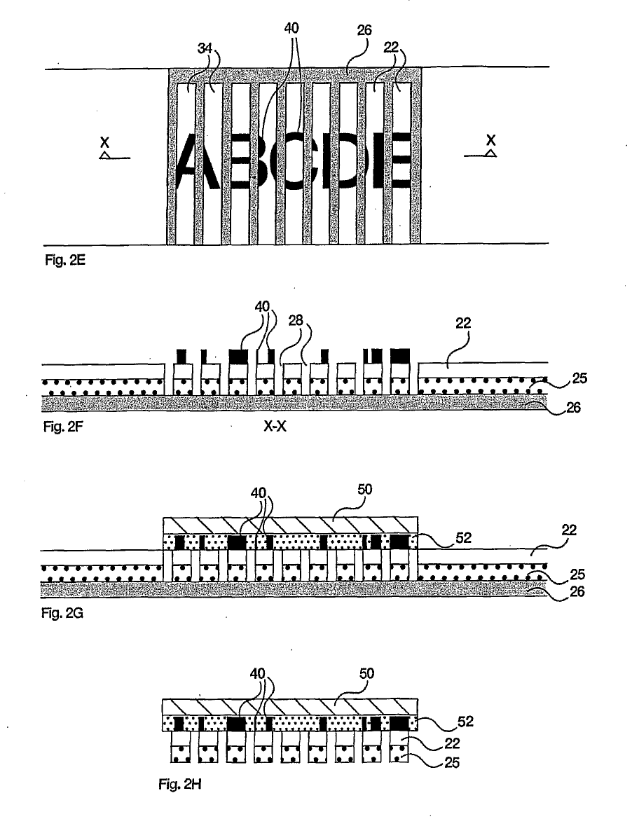

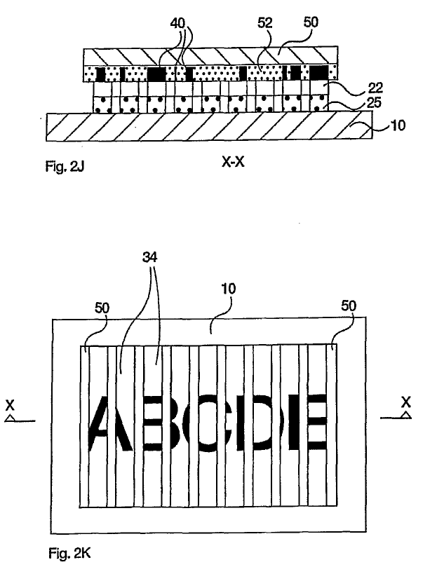

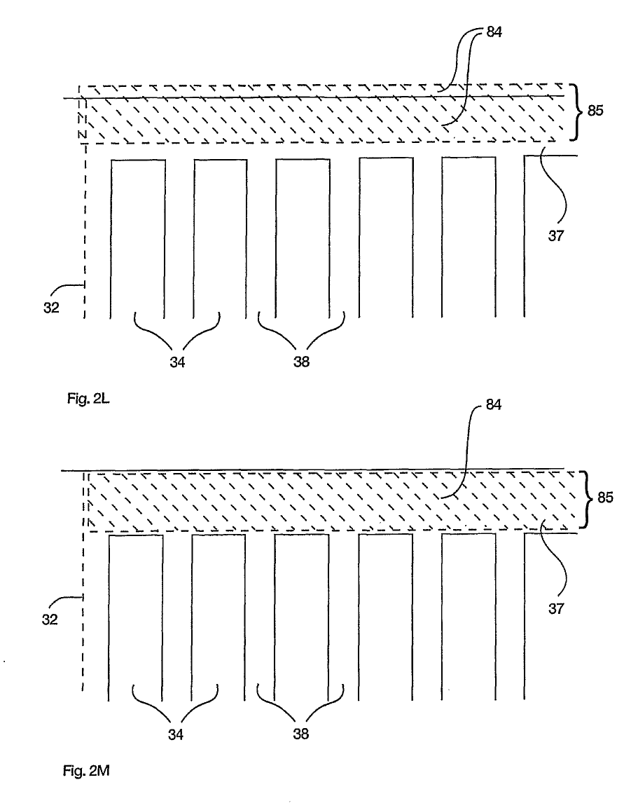

All the FIGS. 2A to 10B and 15A to 19F are diagrammatic and not to scale.

FIGS. 2A-M, 3A-L and 4A-G all illustrate production stages and cut film patterns of the first embodiment in which unwanted material 36 is removed from a liner 26 of a self-adhesive assembly 20 leaving a cut film pattern 34 on the liner 28.

In FIGS. 2A and 2B, the film material is the facestock film 22 of a self-adhesive film 20 comprising the facestock film layer 22, a pressure-sensitive adhesive layer 25 and a removable liner layer 26. The facestock film 22 is kiss-cut into a cutting pattern 30 which defines the cut film pattern 34 and removable elongate film areas 38. The cut film pattern 34 comprises elongate areas 33. The removable elongate film areas 38 are interconnected by a width of film at one edge of the roll or sheet of self-adhesive film 20, which forms the removal connector area 37, and which together comprise unwanted material 36. Extra cuts 32 enable the removal of all the unwanted material 36 in a single “sweep” or “pull” initiated at the edge of the removal connector area.

In the cross-section of FIG. 2B, facestock film 22 is adhered to removable liner 26 by adhesive layer 25, typically a pressure-sensitive adhesive or a heat bondable adhesive. Cutting pattern 30 defines the cut film pattern 34 and unwanted material 36.

This removal of unwanted film is undertaken by hand or automatically, for example using an additional adhering element, for example an adhesive tape or an adhering roller with an adhering surface or by means of an edge of film gripping device which typically grips the edge of the film material after any required separation from a liner and then rotates and then translates across the width of the film in line with the elongate film areas. Such removal of unwanted material reveals removable liner 26 surrounding the cut film pattern 34, as illustrated in FIG. 2C. The remaining facestock film 22 is underlain by adhesive 25 (not visible). FIG. 2D is a longitudinal cross-section X-X through the roll of film in FIG. 2C illustrating the gaps 28 between the elongate film areas 38 of cut film pattern 34. FIG. 2E illustrates the cut film of pattern 34 imaged with design 40, for example by a digital thermal transfer machine, such as the Roland P600, which images the cut film pattern but not the underlying removable liner 26. FIG. 2F is a longitudinal cross-section X-X through the assembly of FIG. 2E, illustrating design 40 superimposed on facestock film 22 but not removable liner 26 in gaps 28. FIG. 2G illustrates the cross-section of FIG. 2F with overlaminate 50, typically a temporary application tape or a clear transparent film, for example polyester, with overlaminate adhesive layer 52. In FIG. 2H the removable liner 26 has been removed and in FIG. 2J the resultant assembly applied to light permeable material 10, typically a window, which is the longitudinal cross section at Y-Y in FIG. 2K, which illustrates the finished panel comprising light permeable material 10, imaged cut film pattern 34 and overlaminate 50.

FIGS. 2L and M illustrate the optional use of an adhering surface 84, typically a self-adhesive tape 85, to assist the removal of removable elongate film areas 38. In part plan FIG. 2L, adhering surface 84, for example a self-adhesive tape 85, is applied to and extends outside removal connector area 37 to optionally:
(i) assist in the separation of facestock film layer 22 and pressure-sensitive adhesive layer 25 from removable liner layer 26 (not shown), for example, by holding the facestock film layer 22 while the removable liner layer 26 is either;
   (a) picked away manually from facestock film layer 22, or
   (b) held by a suction device such as a vacuum suction bed while the self-adhesive tape 85 and the attached facestock film layer 22 and pressure-sensitive adhesive layer 25 are pulled away from the suction held removable liner layer 26, or
   (c) attached to another self-adhesive tape (not shown) and the self-adhesive tape and then another self-adhesive tape are pulled apart, so separating the facestock film layer 22 and the pressure-sensitive adhesive layer 25 from the removable liner layer 26 or,
(ii) reinforce the strength of removal connector area 37 in performing its function of removing the removable elongate film areas 38 in one pull without tearing of the removal connector 37.

FIG. 2M is similar to FIG. 2L except that adhering surface 84, typically self-adhesive tape 85, is only applied within the area of removal connector area 37 to perform function (ii) above, especially in the case of automated removal of removable elongate film areas 38 by means of discrete suction devices positioned at intervals along removal connector area 37, for example using equipment supplied by MGE/Dicon, USA, which also comprises a suction device such as a vacuum suction bed to hold down the removable liner layer 26 (not shown). The self-adhesive tape 85 increases the strength of removal connector area 37 in spanning between the discrete suction devices (not shown) without tearing of removal connector area 37, in order to reduce the required number of such discrete suction devices.

The methodology of FIG. 2L or FIG. 2M can be applied to any of the following variants of the first embodiment.

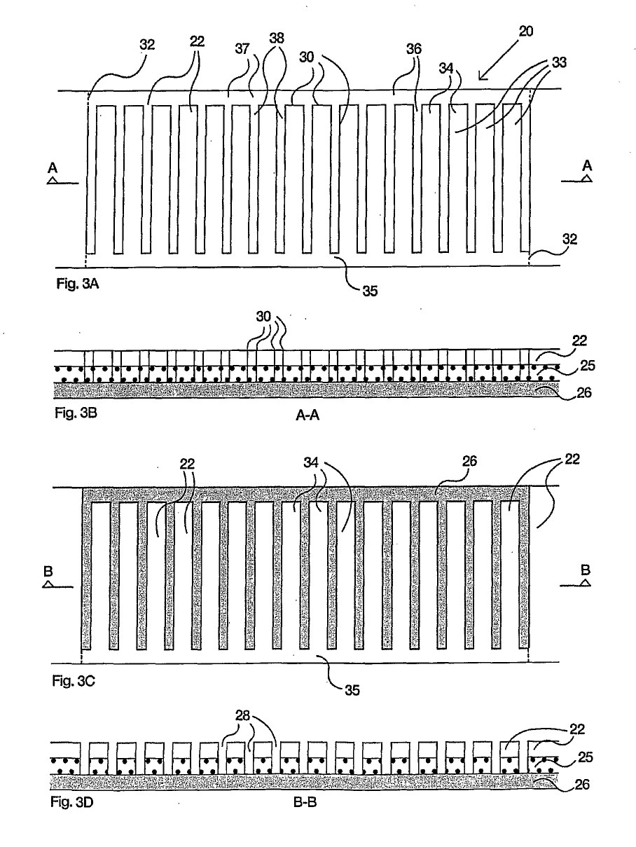

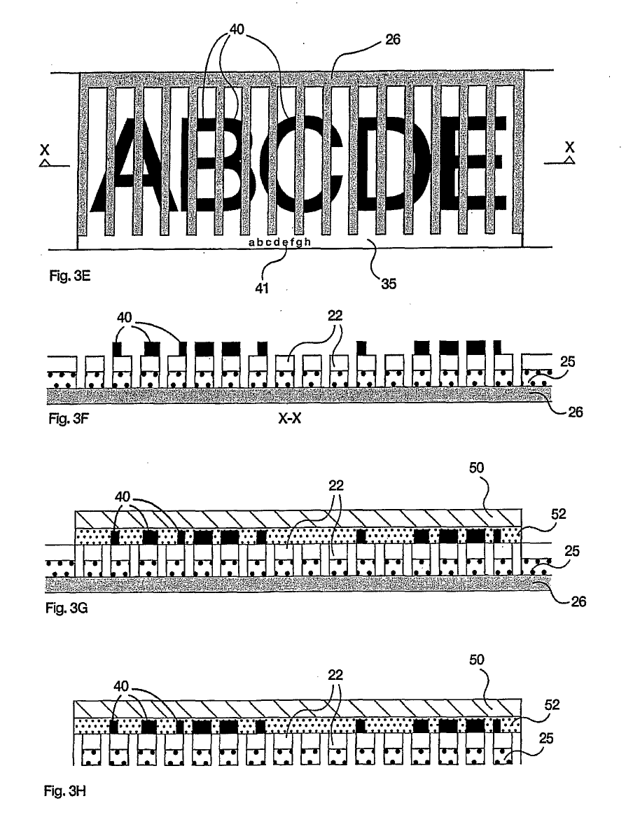

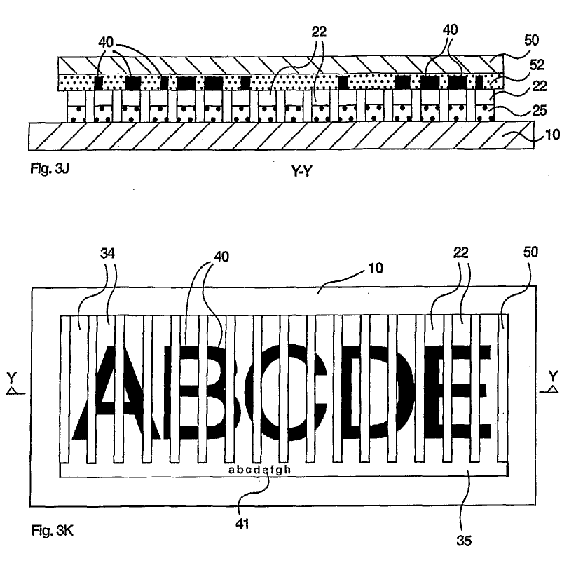

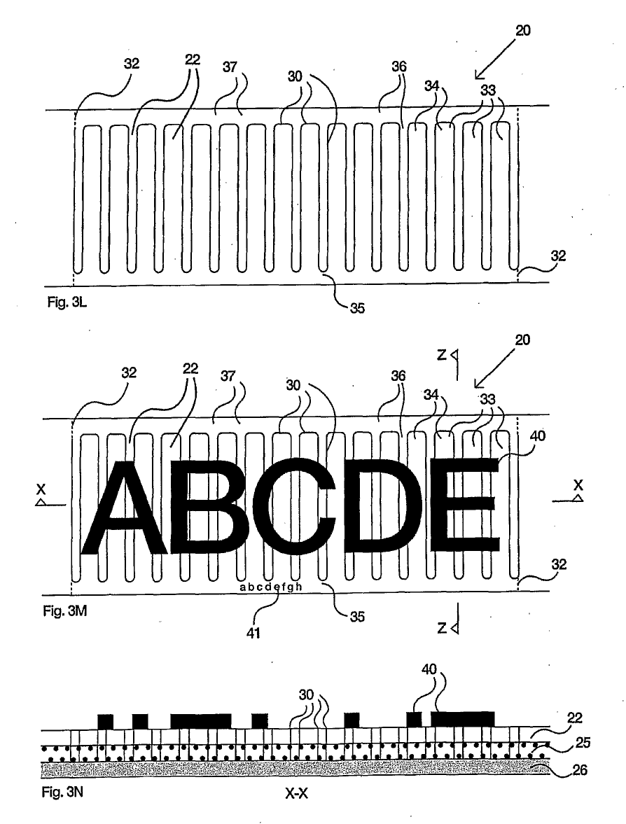

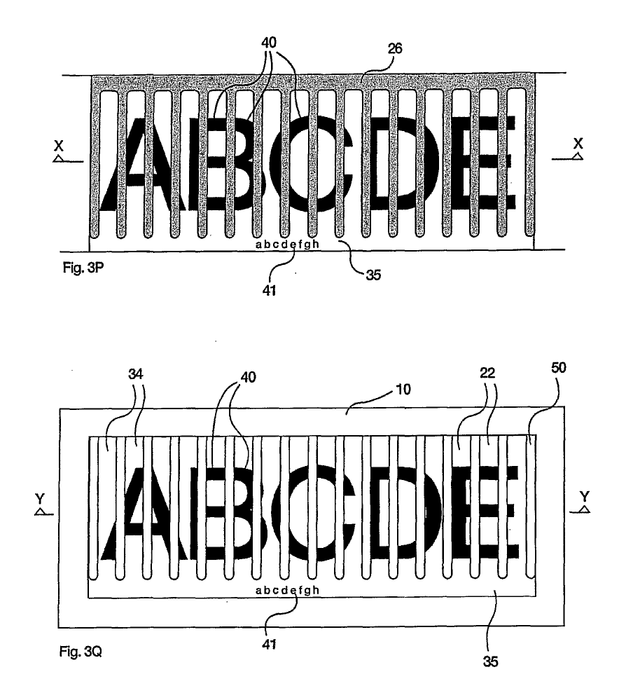

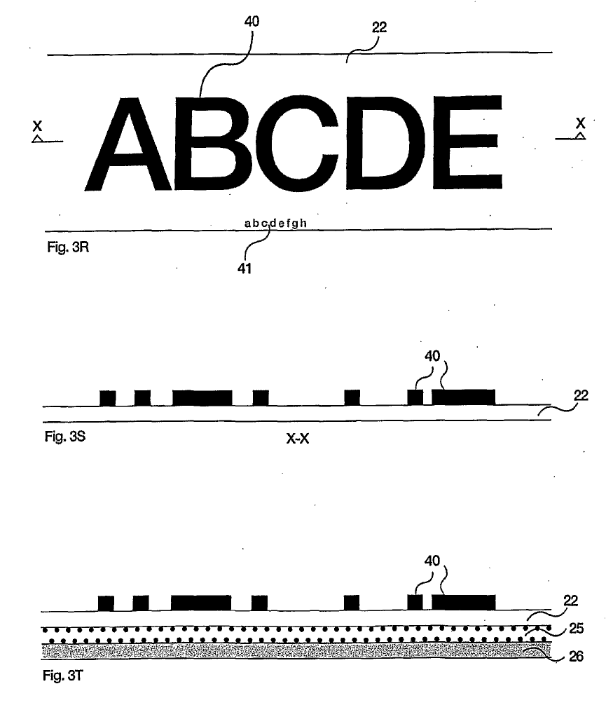

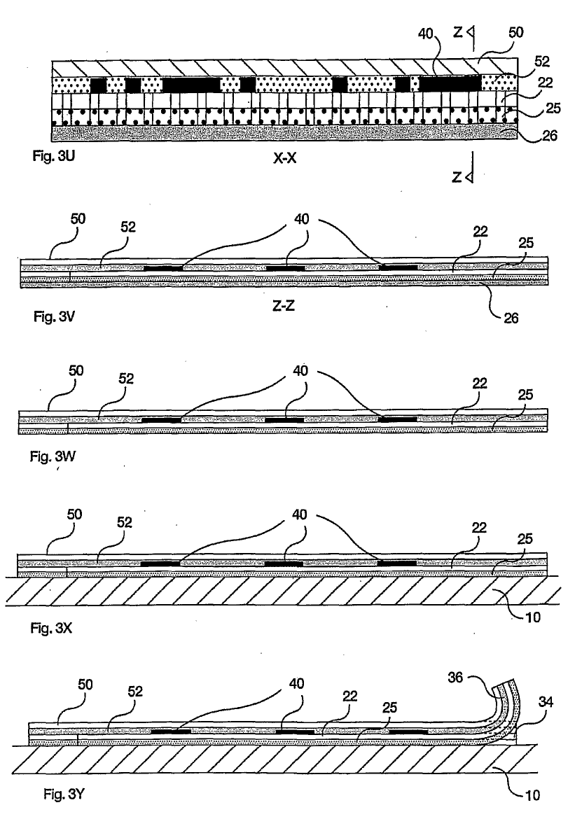

FIGS. 3A-K illustrate a similar production sequence to FIGS. 2A-K.

In FIGS. 3A-K, the film material is also the facestock film 22 of a self-adhesive film 20 comprising the facestock film layer 22, a pressure-sensitive adhesive layer 25 and a removable liner 26. However, the facestock film 22 is kiss-cut, for example, by means of a computer controlled blade or heated element, into a cutting pattern 30 that is spaced within the edges of the roll or sheet of self-adhesive film 20, in order to avoid edge impact of the cutting device or problems caused by any edge curling of the self-adhesive film material. The cut film pattern 34 comprises elongate film areas 33 and residual connector area 35, as illustrated in FIGS. 3A, C and E and, optionally, this residual connector area 35 is maintained in the finished panel, as illustrated in FIG. 3K. FIGS. 3E and 3K also illustrate fine detail design 41 of small indicia printed onto the residual connector area 35 to enable these small indicia to be legible in the finished vision control panel. The removable elongate film areas 38 are interconnected by a width of film at one edge of a roll or sheet of film 20, which forms the removal connector area 37, and which together comprise unwanted material 36. Preferably, the self-adhesive film 20 is in the form of a roll. Extra cuts 32 are typically made by a separate cutting device on the printing and/or cutting machine or by hand. A preferred cut film pattern 34 is a series of elongate rectangular stripes cut perpendicular to the web direction of the roll, as illustrated in FIGS. 3A, C, E and K.

It is advantageous for at least the ends of the elongate film areas 33 to be curved to eliminate or reduce “notch effect” localised stresses in the subsequent process of removing the unwanted film, for example as illustrated by cutting pattern 30 in FIG. 3L.

FIG. 3M shows the kiss-cut self-adhesive film 20 imaged with a design 40 of large indicia and design element 41 of small indicia, longitudinal cross section X-X being illustrated in FIG. 3N. FIG. 3P illustrates unwanted material removed to reveal liner 26. The production process is then similar to previously illustrated in FIGS. 3F, 3G, 3H and 3J, resulting in the finished panel of FIG. 3Q.

FIGS. 3R-Y illustrate a sub-method of the first embodiment in which film 22 is first imaged with design 40, as illustrated in FIG. 3R and cross-section X-X in FIG. 3S. FIG. 3T shows the self-adhesive layer 25 and removable liner 26 added to the side of film 22 remote from design 40. This is typically followed by kiss-cutting the imaged film 22 as illustrated in FIG. 3M and subsequently processed in the same manner as 3N, 3P, 3F, 3G, 3H and 3J, resulting in the finished panel of FIG. 3Q.

Another sub-method of the first embodiment is illustrated by FIGS. 3U-Y, in which the cut, imaged assembly of FIG. 3N has application tape 50 with its adhesive layer 52 applied to the imaged surface of film 22. FIG. 3V is a transverse section Z-Z through the construction of FIG. 3U but with a greater proportion of width to thickness of each layer. FIG. 3W shows liner 26 removed. FIG. 3X shows the self-adhesive assembly applied to light permeable material 10, typically a window. This sub-method enables the removal of unwanted material 36 from the light permeable material, as illustrated in FIG. 3Y, leaving the imaged cut film pattern 34 on the window to form the finished vision control panel, as illustrated in FIG. 3Q but without overlaminate 50.

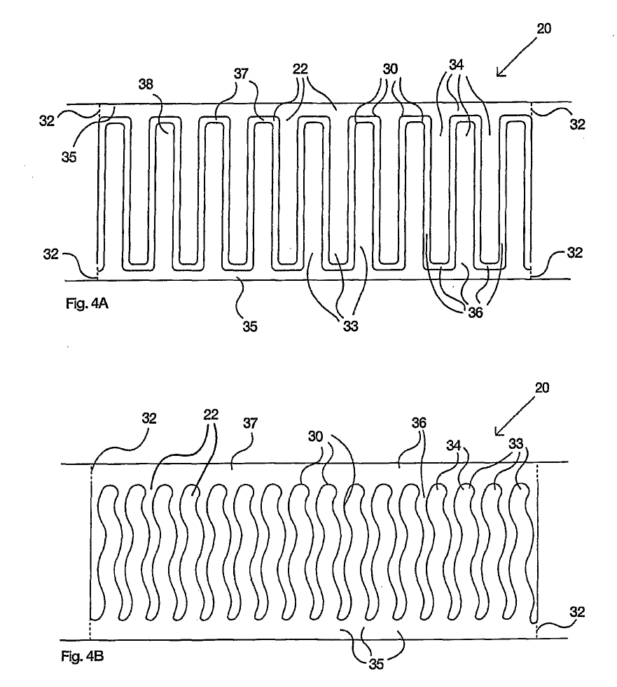

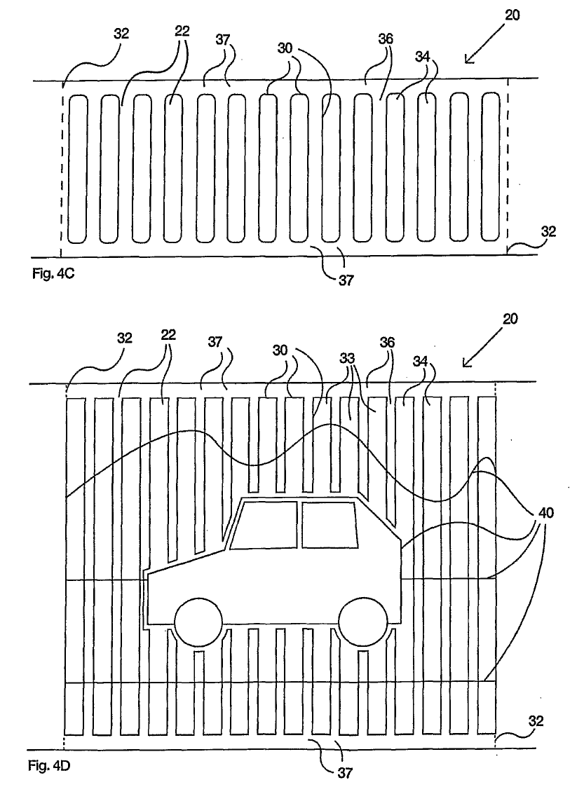

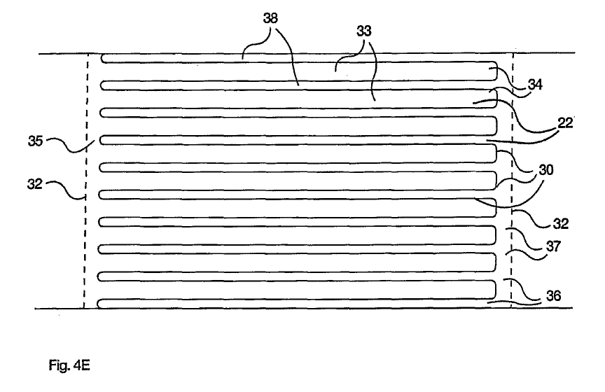

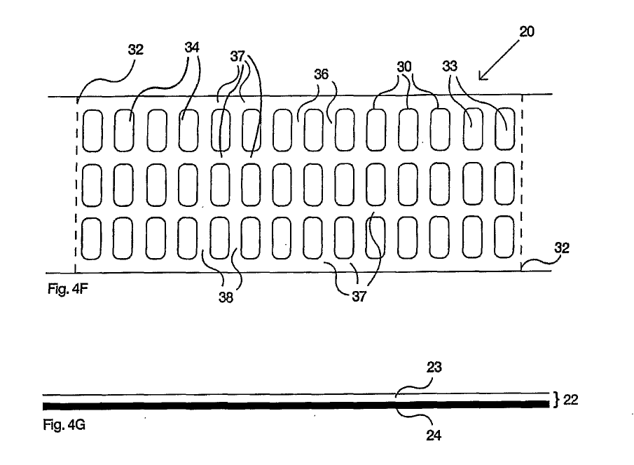

FIGS. 4A-F illustrate some alternative cutting patterns 30, suitable for the first embodiment of the invention.

FIG. 4A illustrates a “parallel zig zag” cutting pattern 30 with cut film pattern 34 comprising elongate film areas 33 and residual connection area 35. Removable elongate film areas 38 are connected by a plurality of removal connector areas 37. This cutting pattern enables the continuous cutting and removal of unwanted material 36 along a roll of film with extra cuts 32 separating individual panels.

Instead of being straight, the sides of the elongate film areas 33 can be curved, for example of sinusoidal curvature as illustrated in FIG. 4B. Such curved elongate film areas overcome the potential problem of straight edges of design features or the top or bottom of lines of indicia being “lost” in a straight gap between straight elongate film areas.

In FIG. 4C the cutting pattern 30 provides removable connector areas connectors 37 on both edges of the roll of self-adhesive film 20, enabling removal of unwanted material 36 from both edges of a roll or sheet of self-adhesive film 20.

FIG. 4D illustrates a cutting pattern 30 which provides a substantially uniform array of elongate film areas 33 surrounding an uncut area on which has been printed the principal feature of design 40. The removable connector areas 37 on each edge of the roll of self-adhesive film 20 enable removal of the unwanted material 36 to leave the design-printed cut film pattern 34 on which the background or surround of design 40 is superimposed.

In FIG. 4E, cutting pattern 30 has longitudinal removable elongate film areas 38 with transverse removable connector area 37, resulting in longitudinal elongate film areas 33 in a cut film pattern 34 which suits certain printers, for example the Gerber Edge™ which has a lateral array of thermal transfer heads which could be damaged by a cut film pattern of transverse elongate film areas.

FIG. 4F illustrates a cutting pattern 30 comprising discrete elongate film areas 34 (shown out of proportion, for clarity) surrounded by unwanted material 36 comprising removable elongate areas 38 and removal connector areas 37. The internal “bridging” removal connector areas 37 are optionally staggered.

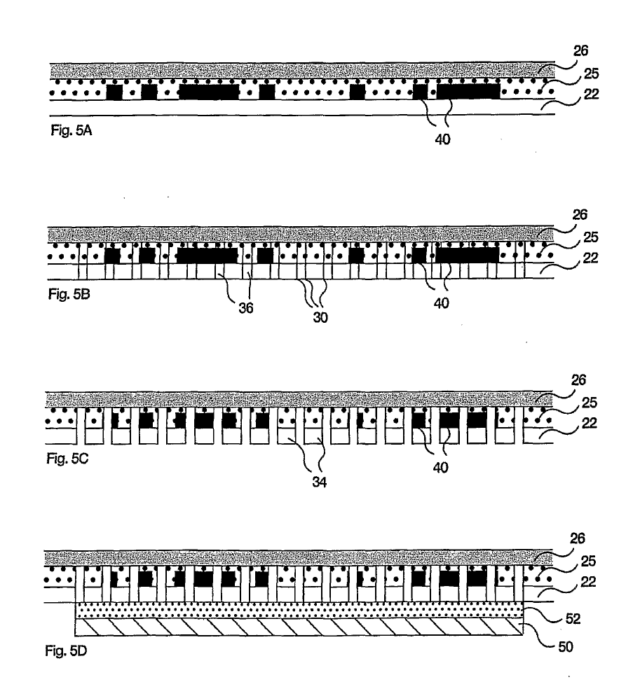

In the diagrammatic representations of the figures, facestock film 22 is illustrated as a single layer. For embodiments intended for external application to a window, film layer 22 typically either comprises a white vinyl layer 23 laminated to a black vinyl layer 24, as illustrated in FIG. 4G, typically used to create vision control panels having an opaque silhouette pattern according to U.S. RE37,186. Alternatively, film 22 typically comprises a single white vinyl layer, in order to form vision control panels with a translucent “base pattern” according to U.S. Pat. No. 6,212,805. Such facestock films can also be used for internal application to a window by creating an assembly with adhesive layer 25 located on the imaged white surface of a white on black film laminated as illustrated in FIG. 4G, or a single white vinyl, if so required, all as illustrated in FIG. 5A-F.

FIG. 5A is a longitudinal cross-section through film 22 that has been imaged with design 40, as in FIGS. 3R and 3S, and to which has been added adhesive layer 25 and removable liner 26 onto the imaged surface of film 22. FIG. 5B shows the assembly kiss-cut with cutting pattern 30 and FIG. 5C shows unwanted material 36 removed to leave imaged, cut film pattern 34. Optionally, an overlaminate or application tape 50 with adhesive layer 52 is applied to the cut film layer 22, as illustrated in FIG. 5D. FIG. 5E illustrates liner 26 removed in order to apply the assembly to light permeable material 10, typically a window, as illustrated in FIG. 5F. In this embodiment, an observer 8 outside window 10 can view the design 40 through the window 10 and transparent adhesive 25. An application tape 50 is subsequently removed or a permanent clear overlaminate 50 and adhesive 52 remains in the finished panel.

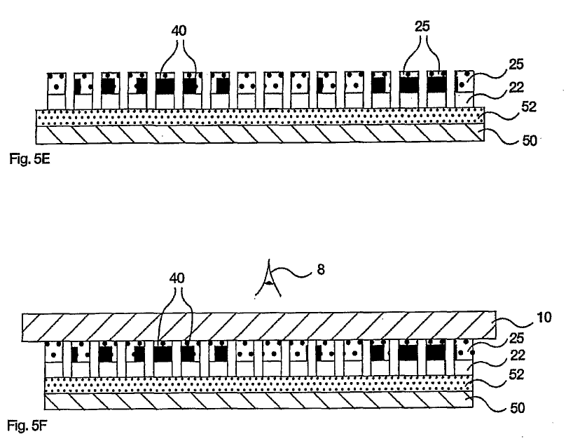

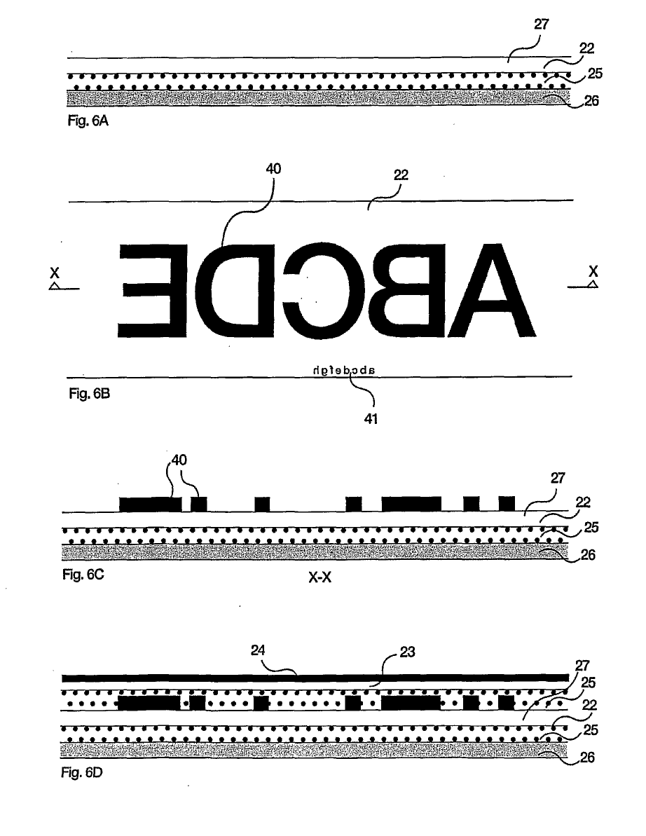

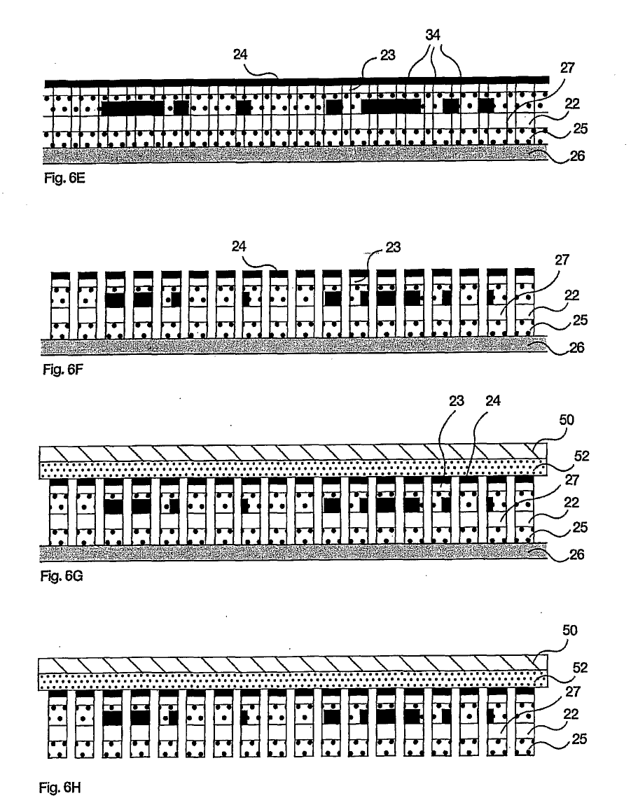

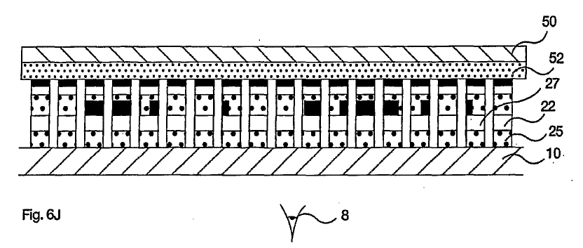

FIGS. 6A-J illustrate an alternative method of applying a cut imaged film assembly to the inside of a window utilising clear, transparent film facestock 27 in a self-adhesive assembly, which also comprises adhesive 25 and removable liner 26, as illustrated in FIG. 6A. In this sub-method, the design 40 and any fine design 41 is reverse printed onto the transparent film facestock 27, as illustrated in FIGS. 6B and C. In order to make a vision control panel with an opaque silhouette pattern according to U.S. RE37,186, it is typically required to apply white and black opacity layers to design 40, for example by screen printing white and black layers or thermally transferring white and black layers of pigmented resin, for example by using heated rollers of a laminating machine. However, the application of the white and black opacity layers can preferably be achieved by the application of a self-adhesive assembly comprising white film layer 23 laminated to black film layer 24, typically both of polyvinyl chloride, with pressure-sensitive adhesive layer 25 adhering the opacity layers to the imaged surface of film 27, as illustrated in FIG. 6D. The resultant assembly is kiss-cut, as illustrated in FIG. 6E, and unwanted material removed to leave the cut film pattern 34, as illustrated in FIG. 6F. FIG. 6G illustrates application or clear overlaminate 50 with adhesive layer 52 applied to the black opacity film layer 24. FIG. 6H shows the liner 26 removed in order to apply the assembly to light permeable material 10 as illustrated in FIG. 6J, in which observer 8 can see the design through light permeable material 10, transparent adhesive layer 25 and transparent film layer 27.

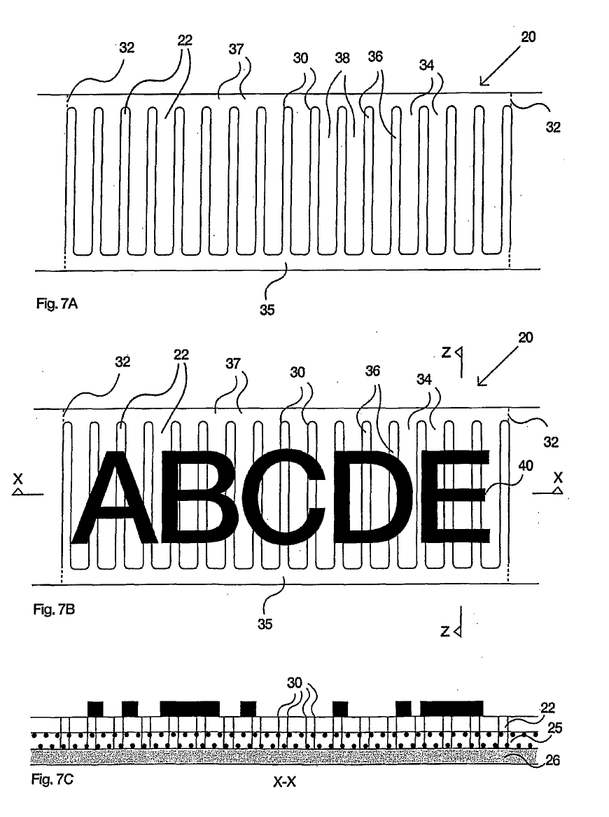

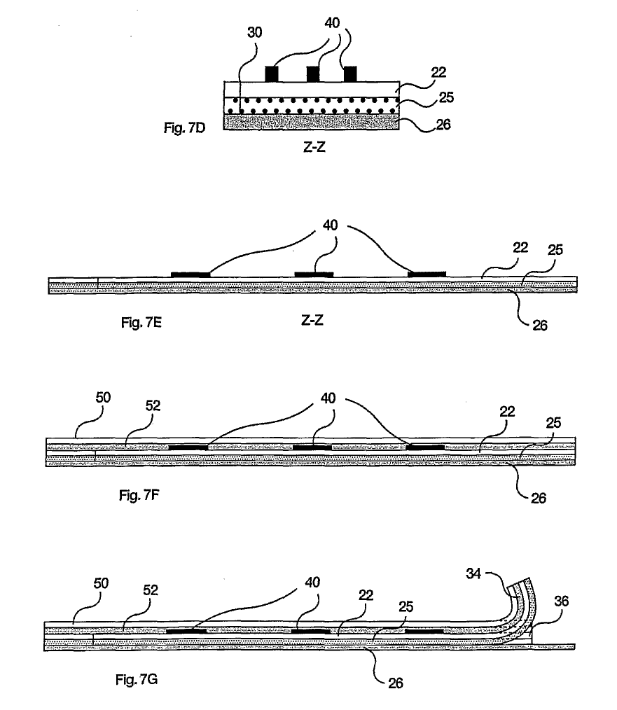

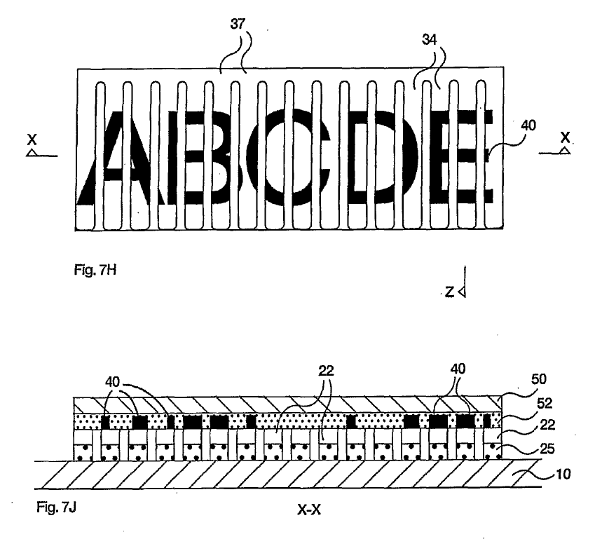

FIGS. 7A-J and 8A-D all illustrate production stages and cut film patterns relevant to the second embodiment of the invention, in which a cut film pattern 34 is removed from a self-adhesive assembly liner 26 leaving unwanted material 36 on the liner 26.

FIG. 7A illustrates self-adhesive film 20 with cutting pattern 30 to achieve cut film pattern 34 comprising removable elongate film areas 38 connected by removal connector area 37 and unwanted material 36 including residual connector area 35. FIG. 7B illustrates the cut self-adhesive film imaged with design 40, shown in longitudinal cross-section X-X in FIG. 7C and cross-section Z-Z in FIG. 7D. FIG. 7E is similar to FIG. 7D but to a different width:thickness ratio. In FIG. 7F, application tape 50 and adhesive layer 52 have been applied to the imaged surface of film 22, which enables the removal of cut film pattern 34 on site and its application to a light permeable material 10, typically a window to form the finished panel illustrated in FIGS. 7H and 7J.

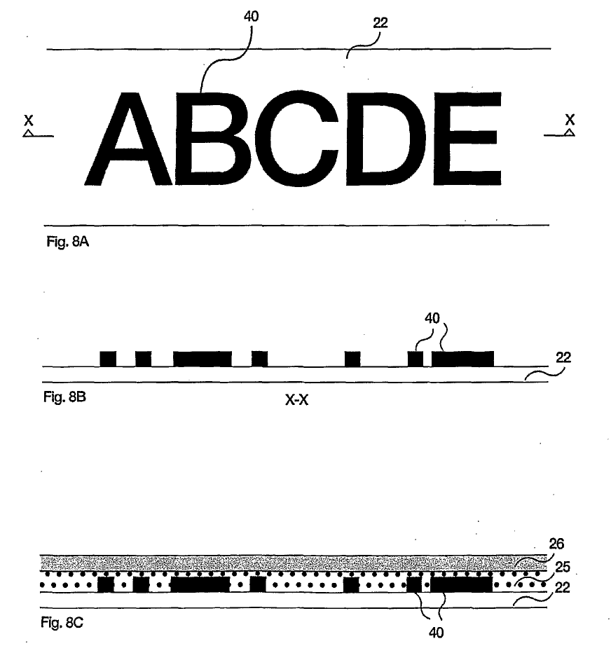

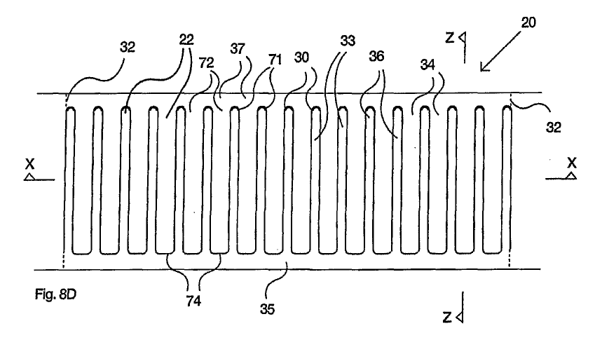

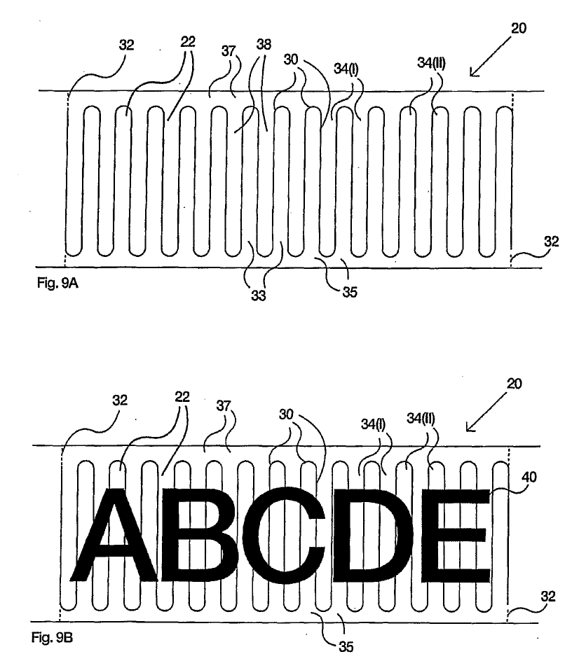

FIGS. 8A-D all illustrate production stages of a sub-method of the second embodiment for application to the inside of a window. In FIG. 8A film 22 is imaged with design 40, as illustrated in cross-section X-X in FIG. 8B. In FIG. 8C, removable liner 26 with adhesive layer 25 are applied to the imaged surface of film 22. FIG. 8D is a plan of the underside of film 22 showing cutting pattern 30 with release ink 71 applied around the curved leading edges of elongate film areas 33 which, together with residual connector area 35, comprise the unwanted material 36 in this sub-method of embodiment 2. The release ink 71 assists the leading edges of removable elongate film area 72 to be separated from the elongate film areas. The release ink 71 is typically a silicone ink applied from a felt pen attached adjacent to a cutting blade.

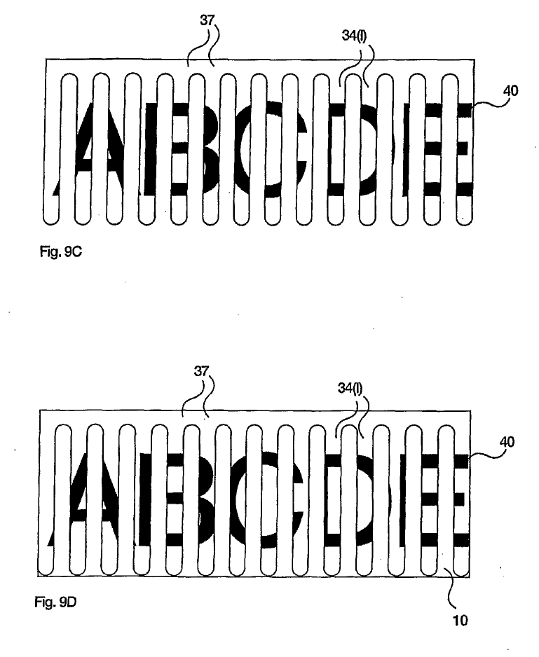

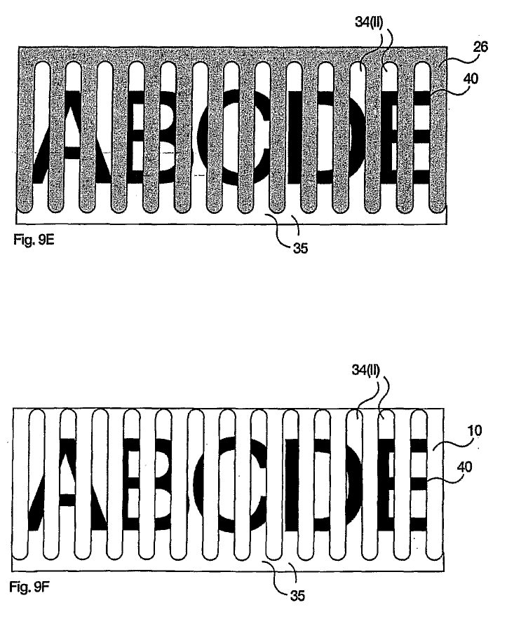

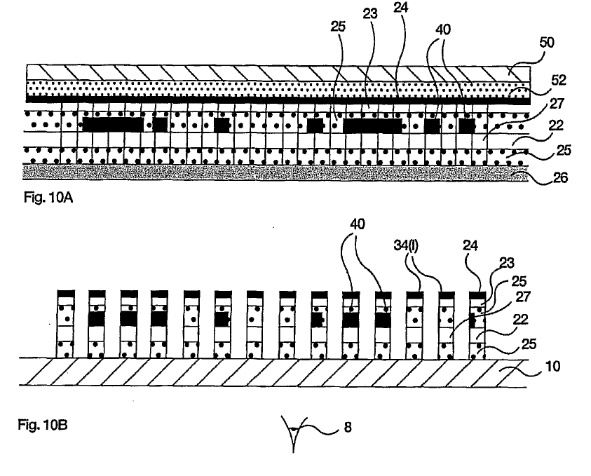

FIGS. 9A to 10B illustrate production stages of sub-methods of the third embodiment in which the film removed from a liner and the film remaining on a liner are both used to create two separate vision control panels. FIG. 9A illustrates cutting pattern 30 creating removable elongate film areas 38 joined by removal connector area 37 to form cut film pattern 34 (I), the removable elongate film areas 38 being typically of equal width to elongate film areas 33 joined by residual connector area 35 to form cut film pattern 34 (II). In FIG. 9B, the cut film is imaged with design 40. FIG. 9C illustrates cut film pattern 34 (I) removed, in order to be applied to light permeable material 10, typically a window, as illustrated in the finished panel in FIG. 9D. FIG. 9E shows cut film pattern 34 (II) and liner 26 following removal of cut film pattern 34 (I), which is processed in a similar manner to the first embodiment to achieve the finished panel illustrated in FIG. 9F with imaged, cut film pattern 34 (II) applied to light permeable material 10, typically a window. FIGS. 10A and B illustrate production stages of the third embodiment for application to the inside of a window. In FIG. 10A, a self-adhesive assembly comprising clear film 27, adhesive 25 and removable liner 26 has been imaged with design 40, followed by white and black vinyl film layers 23 and 24 applied by means of adhesive 25. The resultant assembly is then kiss-cut and application tape 50 with adhesive 52 is applied to enable removal of a cut film pattern (I), to be applied to a light permeable material 10, typically a window, followed by removal of the application tape 50 and adhesive 52, as illustrated in FIG. 10B. The cutting pattern 34 (II) remaining on the liner is processed as described in FIGS. 9E and 9F to achieve a similar cross-section to FIG. 10B in the second vision control panel.

FIGS. 2A to 10B illustrate only a small proportion of the possible sub-method variants of the three possible embodiments of the invention. In all embodiments and sub-methods, more than one cutting blade is optionally used to speed production, typically controlled by a single computer.

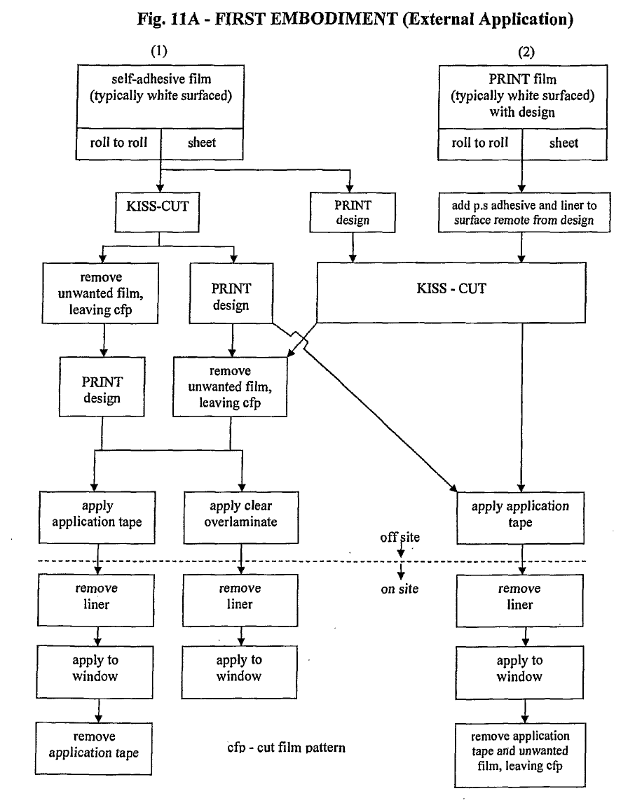

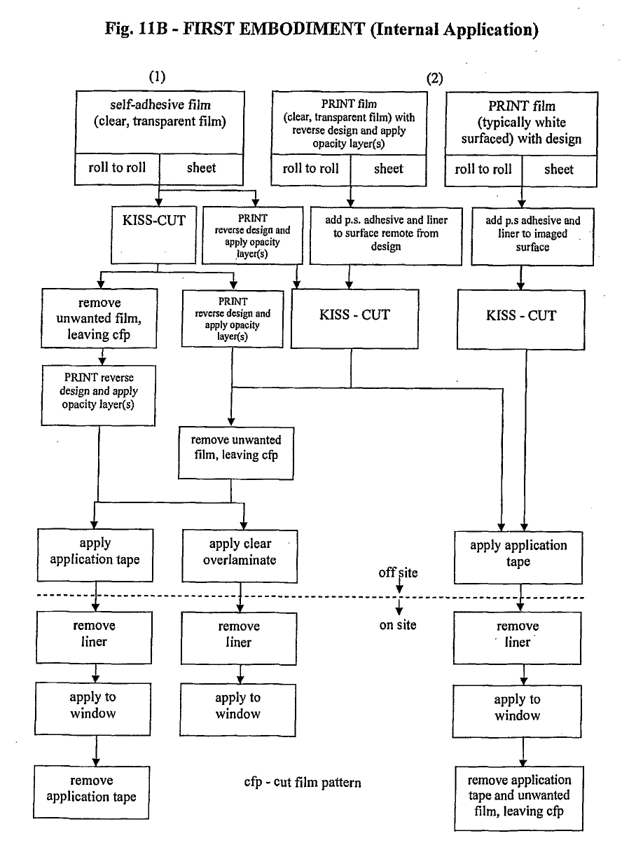

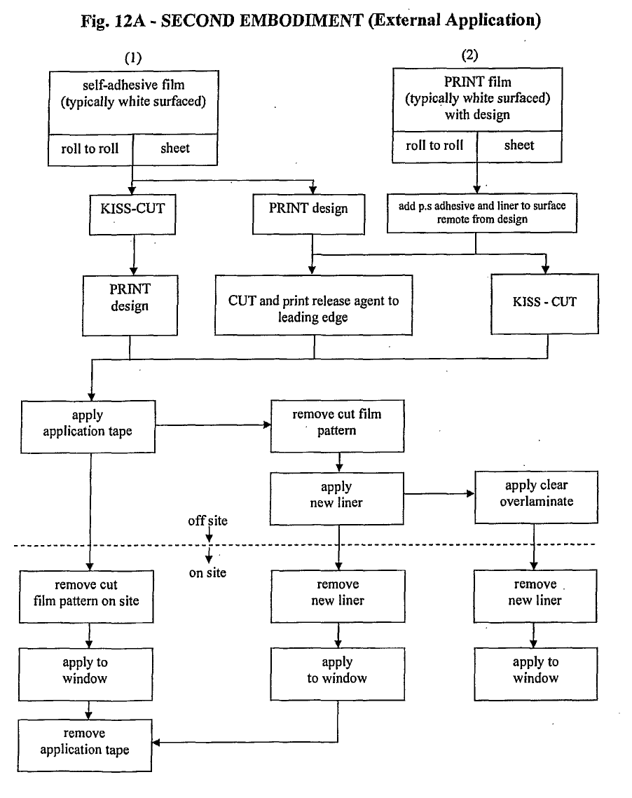

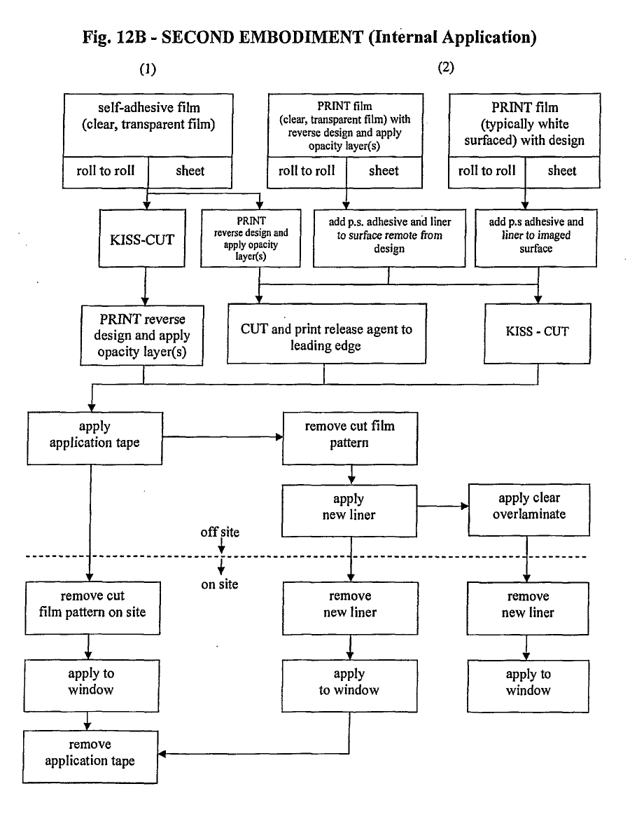

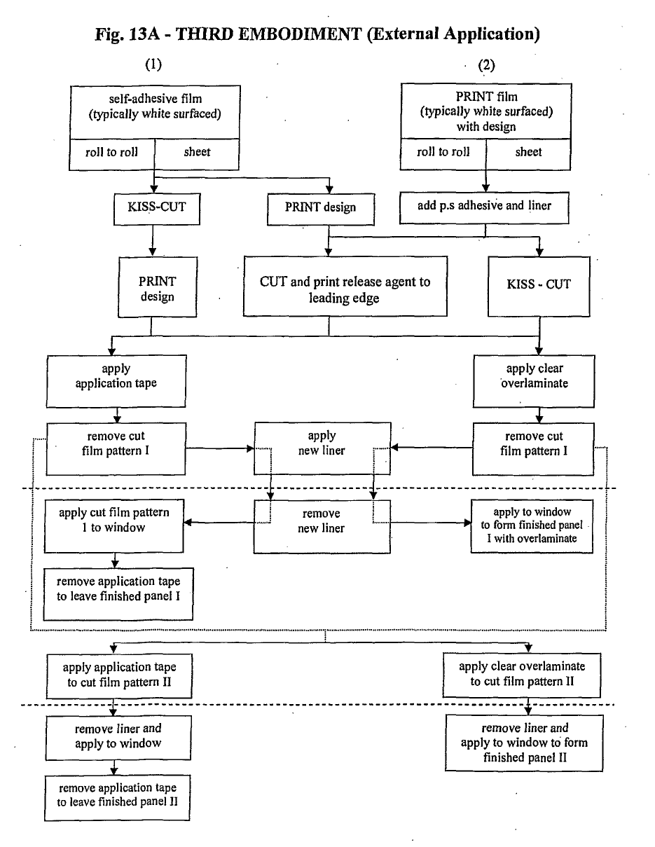

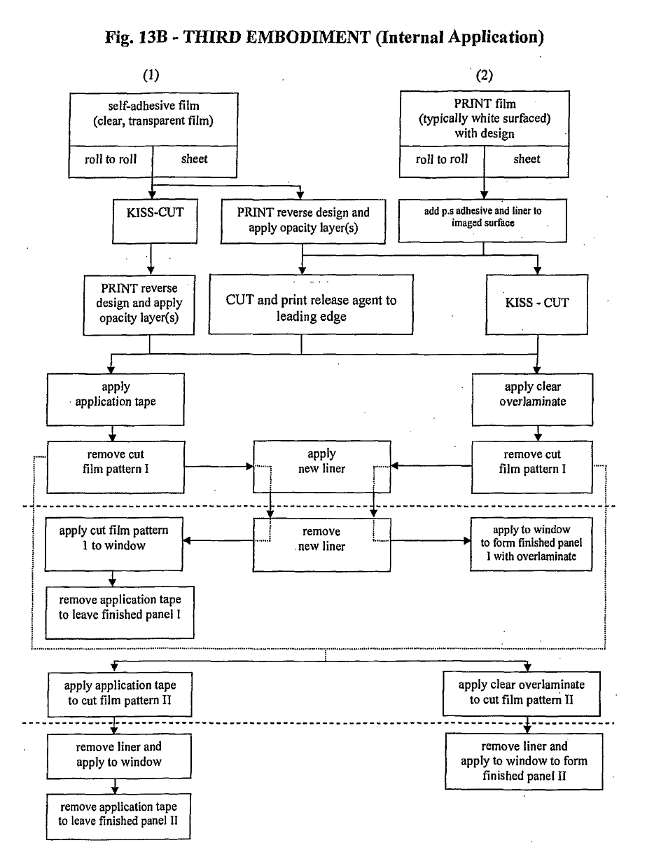

FIGS. 11A to FIG. 14 enable a wider variety of variants to be understood and followed to produce vision control panels according to one or more embodiments of the invention.

FIGS. 11A and B, 12A and B, and 13A and B are flow charts illustrating alternative sub-methods within the first, second and third embodiments respectively.

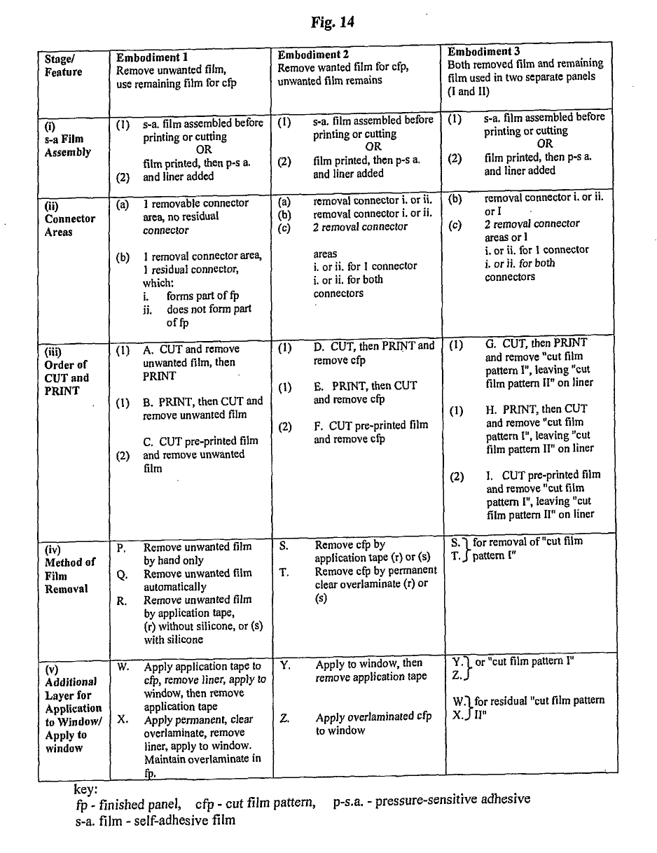

FIG. 14 illustrates the method options of the first, second and third embodiments for each principal stage of production, indicating:
(i) how the self-adhesive assembly is produced,
(ii) the alternative arrangements of connector areas to elongate film areas,
(iii) the alternative orders of cutting and printing the film,
(iv) the alternative methods of film removal, and
(v) the alternative provisions of an additional layer to assist application of the cut film pattern to a window to form a vision control panel and, optionally to assist the removal of unwanted film from a window, or to form an overlaminate as an integral part of the finished vision control panel.

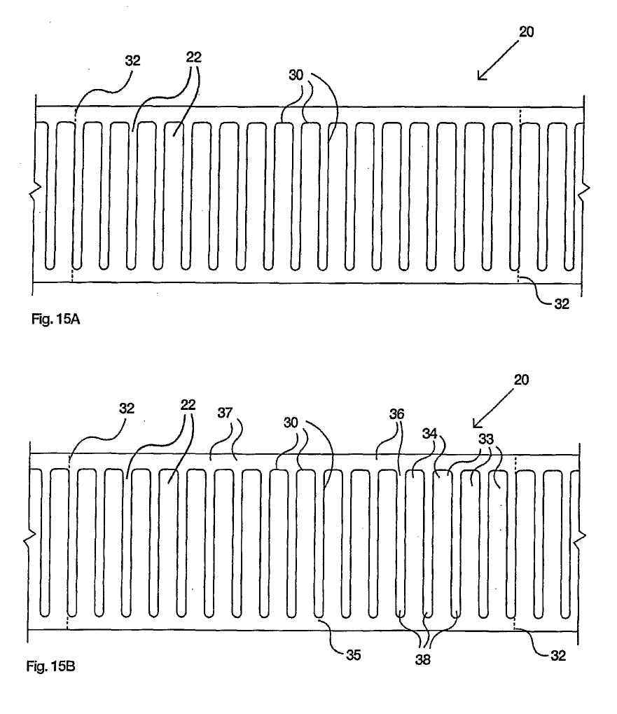

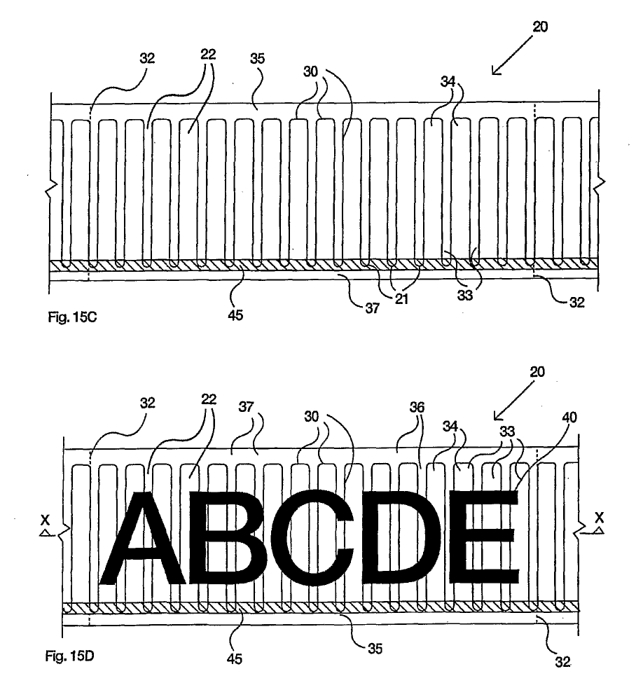

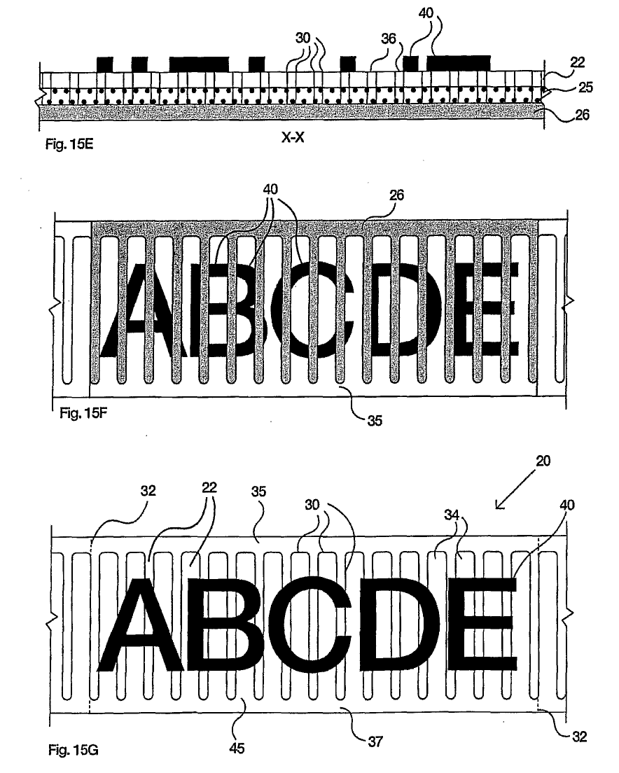

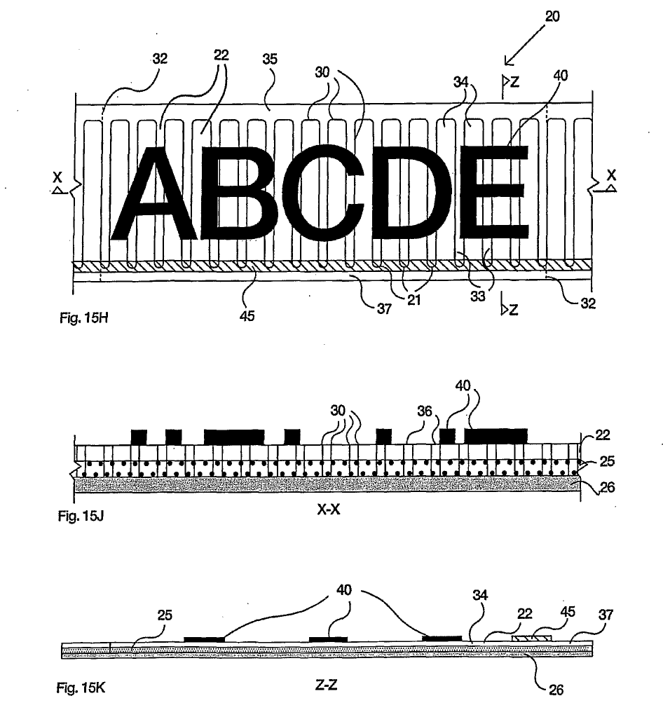

FIGS. 15A-N illustrate the use of a cut film “part processed material” which can be converted according to either the first embodiment or according to the second embodiment. In FIG. 15A a roll of self-adhesive film 20 is kiss-cut throughout its length, through the facestock film 22, with cutting pattern 30, typically with alternating thicker and thinner elongate areas.

FIG. 15B illustrates how this part processed material would be converted by a printer who has purchased a roll of the pre-cut film by means of the first embodiment. Removal connector area 37 joins the thinner removable elongate film areas 38 to form the unwanted material 36 to be removed to leave the cut film pattern 34 comprising the wider elongate film areas 33 and the residual connector area 35 which is optionally removed in the finished panel. The part processed material optionally has release agent 45 in a continuous line to assist converting according to the second embodiment. Release agent 45 straddles the leading edges 21 of elongate film areas 33, preventing these being lifted on subsequent removal of the cut film pattern 34 by means of removal connector 37 and temporary application tape.

FIGS. 15D-G illustrate the conversion of this cut film part processed material according to the first embodiment and FIGS. 15H-N illustrate the conversion of this cut film part processed material according to the second embodiment.

According to the first embodiment, FIG. 15D illustrates the part processed material of FIGS. 15A and B imaged with design 40 between extra cuts 32 determining the length of the cut film pattern 34. This arrangement is shown in cross-section in FIG. 15B. In FIG. 15F, the unwanted material 36 has been removed to reveal removable liner 26. Clear overlaminate 50 is applied to cut film pattern 34 with design 40 before removal of the removable liner 26 and application of the remainder of the assembly to light permeable material 10, typically a window, as shown in FIG. 15G.

FIG. 15H is similar to FIG. 15C with design 40 added, shown in longitudinal cross-section in FIG. 15J. FIG. 15K is a transverse cross-section to a different diagrammatic scale, showing release layer 45. FIG. 15L shows temporary application tape comprising paper or film layer 50 and adhesive layer 52 applied over the assembly to enable removal of removable connector area 37 with cut film pattern 34 imaged with design 40. The removal assembly is applied to a light permeable material 10, typically a window, and the temporary application tape 53 removed to leave the finished panel of FIG. 15N.

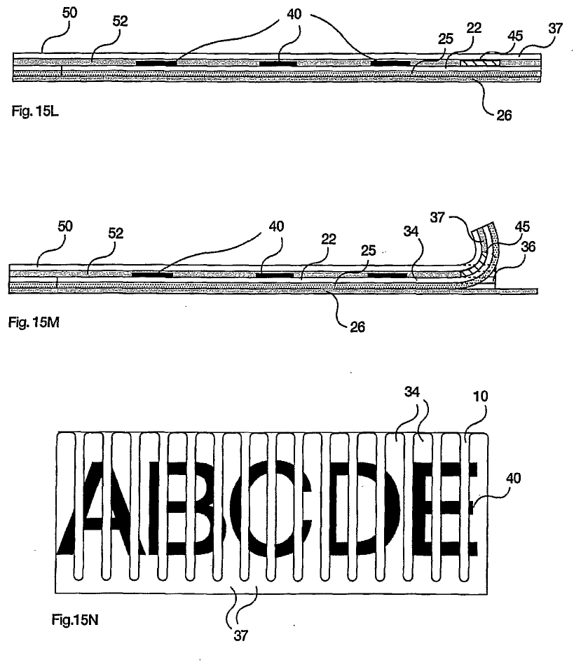

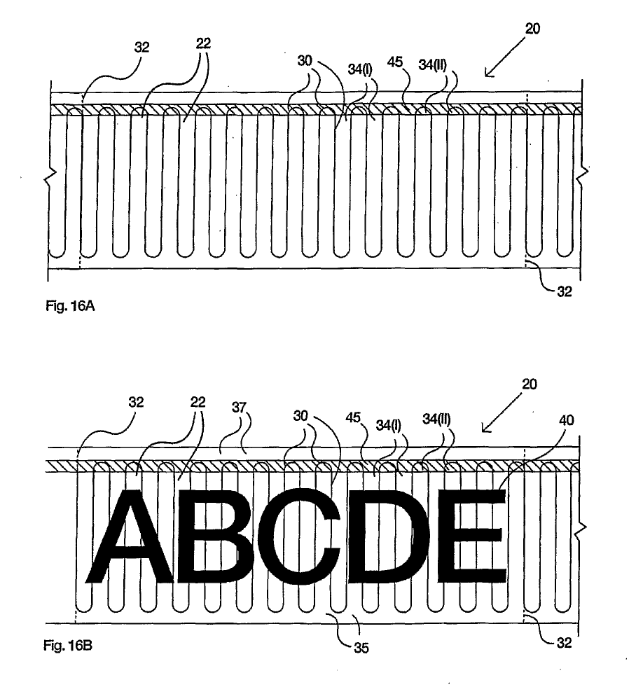

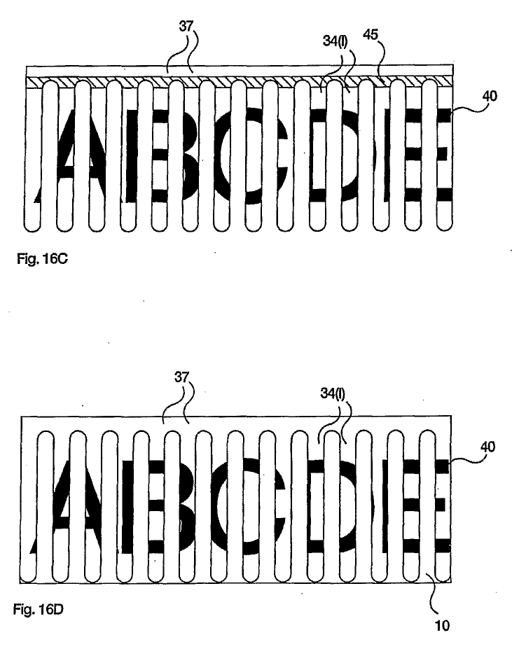

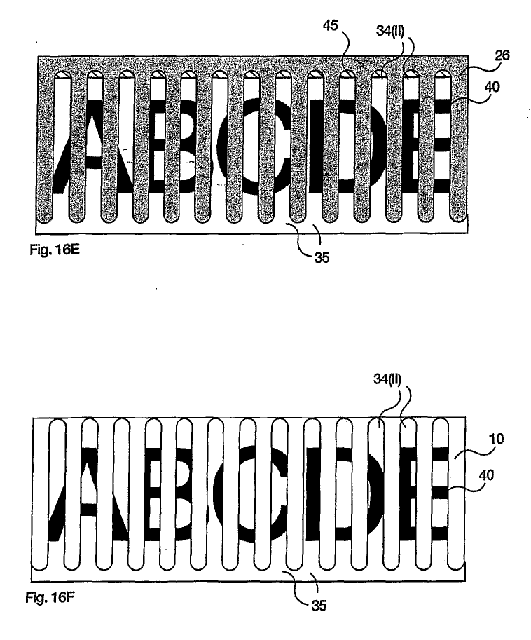

FIG. 16A illustrates a cut film part processed material, typically with a cutting pattern 30 of equal width of elongate areas, intended to be converted according to the third embodiment with cut film pattern 34(I) and cut film pattern 34(II).

In all of FIGS. 15A-C and FIG. 16A, the extra cuts 32 indicate one means of cutting a required length of a cut film part processed material for a particular panel. However, other methods of cutting to length are optionally used, including substrate cross-cutting devices built into printers or X-Y plotter/cutters or by guillotine.

The part processed material cutting pattern 30 is typically pre-cut by a cylindrical die cutting machine or one or more cutting knives on a plotter/cutter. In all embodiments, the removable liner 25 optionally projects from the facestock film 22 and adhesive layer 25 by a small dimension, for example between ⅛″ and ¼″, to facilitate the separation of the facestock film 22 and adhesive layer 25 from the liner when removing the removal connector area.

In FIG. 16B, the part processed material has been imaged with design 40. In FIG. 16C, imaged cut film pattern 34(I) has been removed with the aid of a temporary application tape (not shown), applied to light permeable material 10, for example a window, and the temporary application tape removed, is illustrated in FIG. 16D. Optionally, the imaged cut film pattern 34(I) is temporarily transferred to an additional liner, typically for transport to a remote site, before removing the additional liner and application of the imaged cut film pattern 34(I) to light permeable material 10.

The cut film pattern 34(II) remaining in FIG. 16F is removed, typically after applying a temporary application tape, and applying it to a light permeable material 10, for example a window, to form a second panel from the same length of part processed material. Release agent 45 is typically transparent, for example clear silicone, and is not shown in the final panel FIGS. 16D and F.

A length of part processed material is optionally cut longitudinally if a design of a width smaller than the width of cut film part processed material is required for a particular project, providing two sections of narrower width which may be separately processed in a similar manner to FIGS. 2A-K.

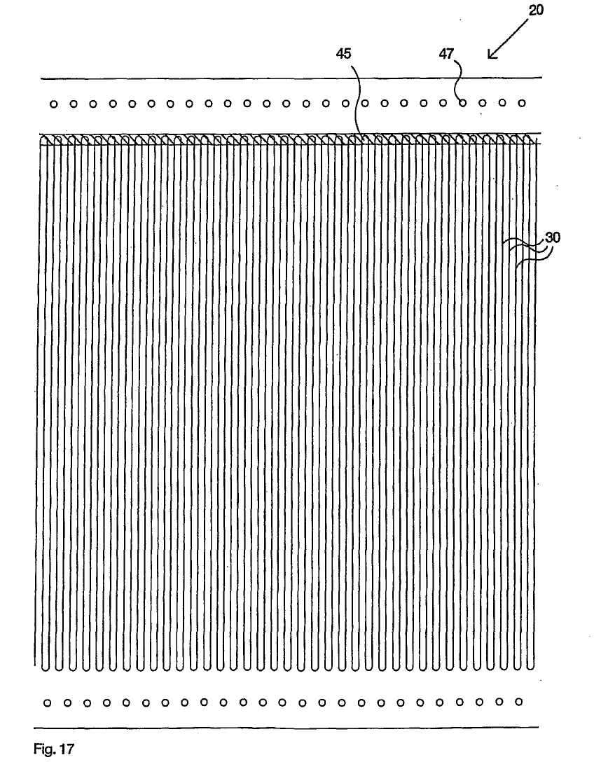

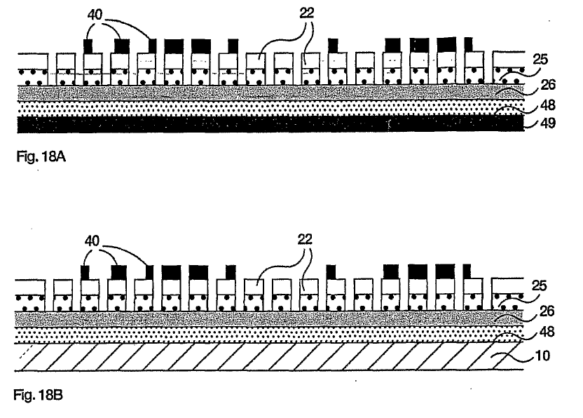

The removed connector area and residual connector area are optionally punched with holes for use in a printing machine that transports substrate by means of sprockets, for example the Gerber Edge™ thermal mass transfer digital printing machine. FIG. 17 is a plan of a length of cut film part processed material with sprocket holes 47 punched and release agent 45 applied outside the print width of such a machine. Typically, such a machine also incorporates a plotter/cutter facility and the cutting pattern 30 is optionally kiss-cut before or after imaging on the same machine.

To make one-way vision graphic panels according to U.S. RE37,186 for external application to a window, the pre-cut self-adhesive assemblies of FIGS. 15A to 17 typically comprise a white on black vinyl facestock film 22 with a clear pressure-sensitive adhesive layer 25 or a white vinyl facestock 22 and black pressure sensitive adhesive, in either case with a release coated liner 26, for example a silicone-coated paper liner.

For internal application to a window, a “water clear” vinyl facestock 22 is typically used with a clear pressure-sensitive adhesive layer 25, with a release coated liner 26, typically a silicone coated paper. The clear, cut vinyl is typically printed with a reverse (mirror) image of the design, followed by the application of white and black “opacity layers”, for example by digital printing or screen printing. Alternatively, these opacity layers are provided by thermal mass transfer of white and black layers of pigmented resin, either separately or combined on a single carrier, typically a polyester carrier, typically by means of a heated-roller laminating device, for example as used in an electrostatic transfer printing process.

To make panels according to U.S. Pat. No. 6,212,805 with a design superimposed on a translucent base pattern which can be illuminated from the other side of the panel, for external application to a window, a white vinyl facestock 22 with clear pressure-sensitive adhesive 25 or a clear vinyl facestock 22 with a white pressure-sensitive adhesive 25 are applied to a released-coated liner 26, typically a silicone coated paper. For internal application a clear vinyl facestock 22 with a clear pressure-sensitive adhesive 25 are applied to a release-coated liner 26, typically a silicone coated paper. A reverse printed design is typically followed by a white translucent base layer of ink, for example either digitally or screen printed, or a white pigmented resin applied by thermal transfer from a carrier, typically a polyester carrier.

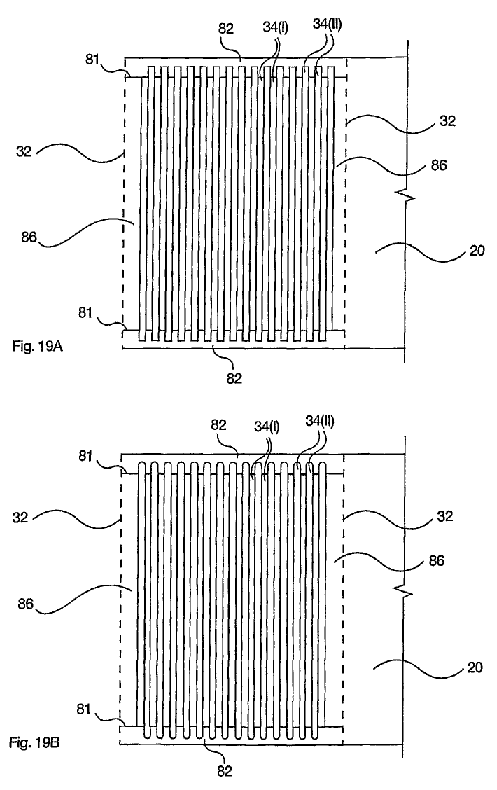

In all embodiments, the release liner 26 is optionally transparent, for example a clear silicone coated polyester film. Optionally, this transparent liner 26 also forms the light permeable material 10 of the finished panel, for example to create a banner which is typically independent of a window. Optionally, the transparent release liner 26 has another layer of clear pressure-sensitive adhesive 48 applied to its surface remote from the facestock film 22 and another release liner 49 applied to the other side of this another layer of pressure-sensitive adhesive 48, as illustrated in FIG. 18A. Such an arrangement removes the need for any temporary application tape or clear overlaminate to carry elongate film areas 33, as they are supported by the release liner 22 during removal of the another release liner 49 and application to a window or other light permeable material 10, as illustrated in FIG. 18B. In this embodiment, to assist application, discrete cuts are optionally made through release liner 26 and adhesive layer 48, to enable trapped air between adhesive layer 48 and light permeable material 10 to escape.

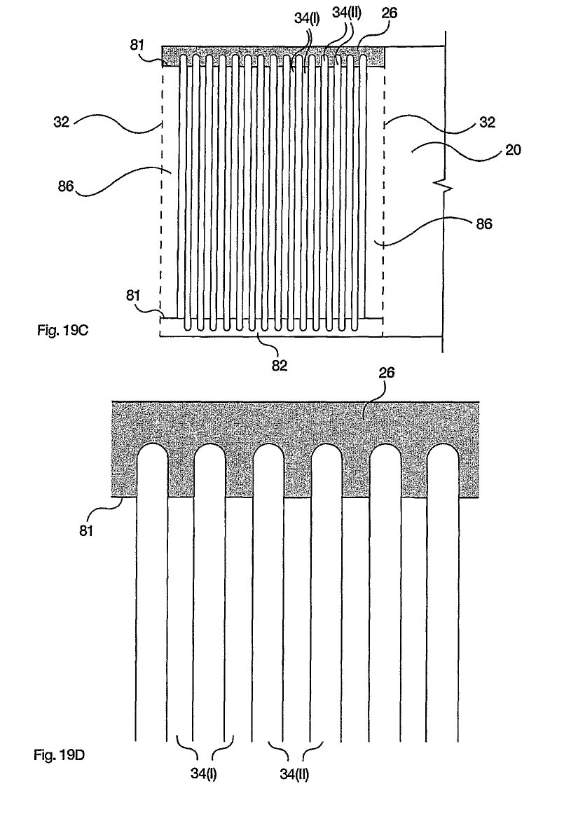

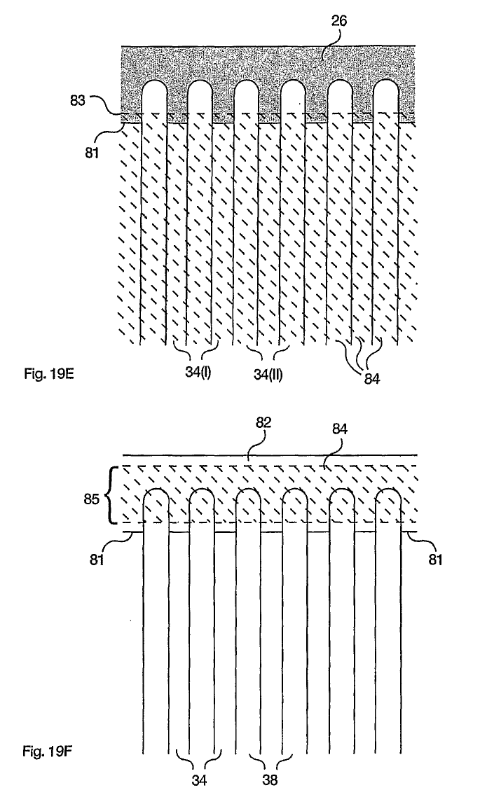

FIGS. 19A-F illustrate embodiments and stages of production in which the leading edges of removable elongate film areas, optionally forming cut film pattern 34 (II), are staggered from, extending beyond, the leading edges of the elongate film areas forming cut film pattern 34 (I).

In FIG. 19A facestock film 20 has cuts 32 extending transversely across the whole width of a self-adhesive assembly roll or web and a cutting pattern of staggered removable elongate film areas to form cut film pattern 34 (II) and elongate film areas to form cut film pattern 34 (I). The leading edges are staggered and a facestock film waste strip 82 is optionally removable up to cut line 81 on both edges of the roll or web. Optional selvedge areas 86 enable printing of a design (not shown) with “bleed” beyond the extremities of cut film patterns 34 (I) and 34 (I).

Preferably, as shown in FIG. 19B, the leading edges of cut film pattern 34 (II) extend beyond cut line 81 and have curved ends, to assist the removal of waste strip 82 without tearing the facestock film.

FIG. 19C shows the assembly following removal of waste strip 82 revealing removable liner 26, also shown in part plan to a larger scale in FIG. 19D.

FIG. 19E illustrates adhering entity 84, for example an application tape, adhered to the facestock film over the majority of the cutting pattern, extending beyond cut line 81 to the edge 83 of the adhering entity but spaced within the leading edges of the removable elongate areas of cut film pattern 34 (II). A pulling force applied to the leading edge 83 of the adhering entity will remove the elongate film areas to form cut film pattern 34 (I) but not the cut film pattern 34 (II), which will remain on liner 26. The adhering entity, typically an application tape, and the attached cut film pattern 34 (I) are then applied to the sheet of light permeable material, typically a window, and the application tape removed to form the finished vision control panel. Another adhering surface, typically another application tape, is then applied to cut film pattern 34 (II), which is similarly transferred to another sheet of light permeable material to form a second vision control panel in accordance with the third embodiment.

FIG. 19F illustrates the use of staggered elongate film areas according to the first embodiment. Adhering surface 84, typically adhesive tape 85, is applied to waste strip 82 and the leading edges of removable elongate areas 38, to enable their removal in a single “pull”, leaving elongate film areas 34 on liner 26 (not shown). The cut line 81 separates the unwanted and removed facestock film from the retained elongate film areas 34, which are transferred to a light permeable material by means of an adhering entity, typically an application tape (not shown), as described previously. In the embodiments illustrated in 19A-F, a design is optionally applied, for example by digital printing before selective removal of facestock film.

Optionally, with machines that can both print and cut, the design is optionally only applied to the cut film pattern or preferably, slightly overlapping the cut film pattern, to allow for production tolerance, for example printing a 75% line pattern and cutting a 70% line pattern within this. Optionally, a similar process to reduce ink usage can be undertaken on separate machines, for example it is possible to first print the design in lines covering, for example, 75% of the film area and also, at the same time, print edge register marks which can be read by a print/cuter optical reading device to enable close registration cutting within the pre-printed lines, for example to achieve a cut film pattern of lines covering 70% of the area.

Pre-cutting of lines before printing is advantageous in that ink, for example that is inkjet or screen printed, can migrate into the cuts and reduce the edge whitening effect that is inevitable if a cut film pattern is observed from an angle from which the white edge of facestock vinyl is visible.

An advantage of pre-cut but not weeded self-adhesive film, compared to the cut film method of U.S. Pat. No. 6,267,052, is that it can be rolled more consistently than a material with discrete lines of self-adhesive film on a liner, the latter being also liable to material distortion owing to the pressure of the discrete elements across the intermediate liner material, especially if the discrete elements become offset in successive layers on a roll. Pre-cut but not weeded self-adhesive film also has a distinct advantage over perforated self-adhesive film for methods of imaging that require a relatively consistent surface. For example the commercial perforation process leaves occasional projecting “slugs” of unremoved material at hole positions that can damage thermal transfer heads in a thermal mass transfer printing machine, whereas the relatively smooth surface of the present invention does not cause such damage.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

1. A method of making a vision control panel comprising the steps of:
(i) cutting a film material in a cutting pattern comprising a plurality of elongate film areas and a plurality of removable elongate film areas; and
(ii) separating said plurality of removable elongate film areas from said plurality of elongate film areas, characterized in that said separating uses an adhering element adhered to said film material.

2. A method as claimed in claim 1, further comprising:
(iii) applying a cut film pattern comprising said plurality of removable elongate film areas or said plurality of elongate film areas to a sheet of light permeable material to cover a substantially uniform proportion of said sheet of light permeable material.

3. A method as claimed in claim 2, wherein said plurality of removable elongate film areas are connected by a removal connector area.

4. A method as claimed in claim 3, wherein said adhering element is applied to said removal connector area.

5. A method as claimed in claim 2, wherein said cut film pattern comprises facestock film of a self-adhesive assembly, said self-adhesive assembly also comprising a removable liner and an adhesive layer intermediate said facestock film and said liner.

6. A method as claimed in claim 2, wherein said adhesive element is a pressure-sensitive adhesive layer.

7. A method as claimed in claim 2, wherein said adhesive element is a heat-bondable adhesive layer.

8. A method as claimed in claim 1, wherein said adhering element is a self-adhesive tape.

9. A method as claimed in claim 2, wherein said cut film pattern comprises said plurality of elongate film areas.

10. A method as claimed in claim 2, wherein said cut film pattern comprises said plurality of removable elongate film areas.

11. A method as claimed in claim 2, wherein said cut film pattern comprises a residual connector area connecting said plurality of elongate film areas.

12. A method as claimed in claim 2, wherein said elongate film areas and said removable film areas are perpendicular to a length of a roll or sheet of said film material.

13. A method as claimed, in claim 10, further comprising applying said plurality of elongate film areas to another sheet of light permeable material to form another vision control panel.

14. A method as claimed in claim 9, further comprising using a self-adhesive application tape to transfer said plurality of elongate film areas to said sheet of light permeable material to form said vision control panel.

15. A method as claimed in claim 10, wherein said adhering element is a self-adhesive application tape, wherein the method further comprises using said self-adhesive application tape to transfer said plurality of removable elongate film areas to said sheet of light permeable material, and wherein said self-adhesive application tape is subsequently removed from said plurality of removable elongate film areas leaving said plurality of removable elongate areas attached to said sheet of light permeable material to form said vision control panel.

16. A method as claimed in claim 10, wherein said adhering element is a transparent overlaminate film, and wherein said transparent overlaminate film is used to transfer said plurality of removable elongate film areas to said sheet of light permeable material to form said vision control panel.

17. A method as claimed in claim 13, wherein a self-adhesive application tape is used to transfer said plurality of elongate film areas to another sheet of light permeable material, and wherein said application tape is removed from said plurality of elongate film areas, leaving said plurality of elongate film areas attached to said another sheet of light permeable material to form said another vision control panel.

18. A method as claimed in claim 2, wherein a design is applied to said film material before said separating.

19. A method as claimed in claim 2, wherein a design is applied to said plurality of elongate film areas after said separating.

20. A method as claimed in claim 18, wherein said design is applied to said film material before said cutting.

21. A method as claimed in claim 2, wherein said film material is white.

22. A method as claimed in claim 2, wherein said film material comprises a white layer laminated to a black layer.

23. A method as claimed in claim 2, wherein said film material is transparent film.

24. A method as claimed in claim 23, wherein a design is reverse printed onto said transparent film.

25. A method as claimed in claim 24, wherein white and black layers are applied to the reverse printed design.

26. A method as claimed in claim 2, wherein said light permeable material is transparent.

27. A method as claimed in claim 1, further comprising, before step (i), applying the film material to a sheet of light permeable material.
